(19) United States
(12) Patent Application Publication
(10) Pub. No.: US 2011/0028603 A1
(43) Pub. Date: Feb. 3, 2011

(54) HYPERBRANCHED POLYMERS AND OLIGOMERS COMPRISING TERMINAL AMINO GROUPS AS CURING AGENTS FOR EPOXY RESINS

(75) Inventors: Maxim Peretolchin, Mannheim (DE); Eva Rueba, Zurich (CH); Daniel Schoenfelder, Bruxelles (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/936,482

(22) PCT Filed: Apr. 9, 2009
(86) PCT No.: PCT/EP09/54299

§ 371 Date: Oct. 5, 2010

(30) Foreign Application Priority Data
Apr. 11, 2008 (EP) 08154436.3

(51) Int. Cl. C08L 63/00; C08G 18/10; C08G 18/32; C08G 69/08; C08G 69/26

(52) U.S. Cl. 523/446; 523/400; 525/418; 525/423; 525/452; 528/61; 528/68; 528/310; 528/335

(57) ABSTRACT

The invention relates to the use of hyperbranched polymers or oligomers comprising terminal primary and/or secondary amino groups as curing agents for epoxy resins. The invention further relates to a composition containing such polymers or oligomers, an uncured or only partially cured epoxy resin, and at least one optional curing agent for epoxy resins, as well as a cured epoxy resin that can be obtained by curing said components. The invention finally relates to a method for curing epoxy resins. In said method, an uncured or only partially cured epoxy resin is brought to a temperature of 5 to 150° C. or is exposed to microwave radiation along with at least one polymer or oligomer according to the definition above and at least one optional conventional curing agent for epoxy resins.

The present invention relates to the use of highly branched polymers or oligomers having terminal primary and/or secondary amino groups as curatives for epoxy resins. The invention further relates to a composition which comprises such polymers or oligomers, an uncured or part-cured epoxy resin, and, optionally, at least one conventional curative for epoxy resins, and to a cured epoxy resin obtainable by curing these components. Finally the invention relates to a method of curing an epoxy resin by bringing an uncured or part-cured epoxy resin with at least one polymer or oligomer as defined above and, optionally, with at least one conventional curative for epoxy resins to a temperature of 5 to 150° C. or exposing it to microwave radiation.

Cured epoxy resins are widespread on account of their outstanding mechanical and chemical properties, such as high impact strength, high abrasion resistance, good chemical resistance, excellent adhesiveness to numerous materials, and high electrical insulation capacity. They serve as a matrix for fiber composites and are often a major constituent in electrical laminates, structural adhesives, casting resins, and powder coating materials.

The term “epoxy resins” has a plurality of meanings and refers firstly to prepolymers which comprise two or more epoxide groups (in some of the epoxide groups the oxirane group may also have been opened to a hydroxyl group), or compositions which comprise these prepolymers. Secondly the term also identifies part-cured or fully cured epoxy resins, i.e., epoxy resins which have been crosslinked by means of suitable curatives. The term is also used, however, to identify modified epoxy resins, such as esterified or etherified epoxy resins, obtainable for example by reaction with carboxylic acids or alcohols. In general as well, compositions which comprise (part-)cured and/or modified epoxy resins are also encompassed by the epoxy resins term. Compositions which comprise uncured, part-cured and/or fully cured epoxy resins are, for example, what are called compounded epoxy resins, i.e., epoxy resins mixed with suitable additives, examples being formulations which as well as the epoxy resin comprise curative(s) (if the epoxy resin is uncured or part-cured) and, optionally, further additives, such as flame retardants, antioxidants, stabilizers, and the like. The compositions may also be composites. A complete definition of the term “epoxy resins” is found for example in Ullmann's Encyclopedia of Industrial Chemistry, 5th edition, on CD-ROM, 1997, Wiley-VCH, in the “Epoxy Resins” section.

In the context of the present invention, and where not further specified, the term “epoxy resin” is used for uncured or part-cured epoxy resins (prepolymers). If it is intended to refer to fully cured or modified epoxy resins or to epoxy resin-containing compositions, this will be specified at the relevant point.

Curatives or curing agents are also referred to as crosslinking agents. They are compounds which, in the case of sufficient reaction, convert the epoxy resin prepolymer into infusible, three-dimensional, “crosslinked”, thermoset structures. A fundamental distinction is made between two types of curatives for epoxy resins: The first type involves compounds with a functionality of at least two whose functional groups are able to react covalently with the oxirane or hydroxyl groups of the epoxy resins, and fully or partly crosslink the prepolymer. The second type, also referred to commonly as initiator or accelerant, catalyzes the homopolymerization of the epoxy resins. Initiators and accelerants are in some cases also added to the first type of curative in order to accelerate crosslinking.

Examples of suitable functional groups which are able to enter into a condensation reaction with the oxirane groups of the epoxy resins are amino groups, hydroxyl groups, and carboxyl groups, and derivatives thereof, such as anhydrides. Accordingly, compounds typically used as curatives for epoxy resins are aliphatic and aromatic polyamines, carboxylic anhydrides, polyamidoamines, aminoplasts or phenoplasts. Known curatives possess a structure which is linear or no more than slightly crosslinked. They are described for example in Ullmann's Encyclopedia of Industrial Chemistry, 5th edition on CD-ROM, 1997, Wiley-VCH, section headed “Epoxy Resins”, which is hereby incorporated in full by reference.

Known curatives with amino groups can be divided into two groups:

The first group is formed by low molecular mass amines, such as diethylenetriamine, triethylenetetramine, Jeffamines, m-phenylenediamine, 4,4′-methylenedianiline (MDA) or bis(4-aminophenyl)sulfone (DADS, DDS or dapsone). They are of low viscosity, possess a high amine number and a high density of functional groups per unit weight or volume, and so lead to products having a high network density. The aliphatic amines, moreover, are highly reactive and in some cases react even under room temperature (25° C.). Disadvantages, however, are their volatility, their unpleasant odor, and their toxicity. In addition, the reactivity of the aliphatic amines is frequently too high, with the consequence that the crosslinking process is uncontrolled. The reactivity of aromatic amines, in contrast, is frequently too low, with the consequence that crosslinking necessarily takes place at high temperatures and with long reaction times, which is of course unwanted from an economic standpoint.

The second group is formed by high molecular mass amines, generally polymers, which comprise amino functions, such as amidopolyamines or polyesters with terminal amino groups. These polymers, though without the abovementioned disadvantages of the low molecular mass amines, also lead, however, to products having a distinctly lower network density, on account of their distinctly lower density of reactive functional groups. A high network density is critically important, however, for the mechanical and thermal stability of the epoxy resin-based products.

It was an object of the present invention, therefore, to provide curatives for epoxy resins that combine the advantages of the prior-art curatives and at the same time avoid the disadvantages—that is, which lead to cured epoxy resins having a high network density and are sufficiently reactive, so that the crosslinking can be carried out at low temperatures and in acceptable reaction times, but which at the same time are nonvolatile, non-foul-smelling, and nontoxic, while yet preferably being as far as possible of low viscosity.

This object has been achieved through the use of highly branched, high-functionality polymers having primary and/or secondary amino groups as terminal groups of the main chains or side chains, and of oligomers having primary and/or secondary amino groups, as curatives for epoxy resins.

The invention accordingly provides for the use of condensation products selected from

(i) highly branched polymers obtainable by the condensation of
(1-1) urea or at least one urea derivative having
(1-2) at least one amine having at least two primary and/or secondary amino groups,
   with at least one amine necessarily comprising at least three primary and/or secondary amino groups;
      (ii) highly branched polymers obtainable by the condensation of
(ii-1) one amine having at least three primary and/or secondary amino groups (self-condensation), or at least two (different) amines having at least two primary and/or secondary amino groups, with at least one of these at least two amines necessarily comprising at least three primary and/or secondary amino groups;
   (iii) highly branched polymers obtainable by the reaction of
(iii-1) at least one at least difunctional di- or polyisocyanate having
(iii-2) at least one amine having at least two primary and/or secondary amino groups,
   with at least one polyisocyanate being at least trifunctional or with at least one amine containing at least three primary and/or secondary amino groups;
      (iv) highly branched polymers obtainable by the condensation of
(iv-1) at least one carboxylic acid having at least two carboxyl groups or at least one derivative thereof having
(iv-2) at least one amine having at least two primary and/or secondary amino groups;
   with at least one carboxylic acid necessarily comprising at least three carboxyl groups or carboxyl group derivatives, or with at least one amine necessarily comprising at least three primary and/or secondary amino groups;
      (v) oligomeric compounds obtainable by the condensation of
(v-1) urea and/or at least one urea derivative having
(v-2) at least one amine having at least two primary and/or secondary amino groups,
   with at least one amine necessarily comprising at least three primary and/or secondary amino groups; and
      (vi) oligomeric compounds obtainable by the condensation of
(vi-1) melamine having
(vi-2) at least one amine having at least two primary and/or secondary amino groups and being different than melamine;
   as curatives for epoxy resins.

In the polymers and oligomers used in accordance with the invention, the terminal primary and/or secondary amino groups may be either amino groups bonded to a carbonyl group (C═O) or a carbonyl-like group [such as thiocarbonyl (C═S) or imine (C═NR)] or “true” amino groups, i.e. amino groups not bonded to a carbonyl function or a carbonyl-like group. Both types of amino groups are suitable as terminal groups and can have crosslinking action under particular reaction conditions, i.e. react with the epoxy group of the epoxy resins. Owing to the higher nucleophilicity, “true” amino groups can react more rapidly than terminal groups; however, this is not always desirable; for example when lower degrees of crosslinking are to be established. The selection of the terminal amino groups depends on the specific intended use and can be decided by the person skilled in the art in the individual case. The terminal amino groups are established by the preparation process, especially through the stoichiometry of the monomers to be polymerized and/or through the sequence of addition for the polymerization reaction.

In the context of the present invention the term “polymer” is understood broadly and encompasses addition polymers, polyadducts, and polycondensates—that is, it does not define the way in which the propagation of the chain proceeds. Most frequently in the present invention it identifies polycondensates.

By highly branched polymers are meant, in the context of the present invention, polymers having a branched structure and a high functionality, i.e., a high density of functional groups. For a general definition of highly branched polymers, refer to P. J. Flory, J. Am. Chem. Soc., 1952, 74, 2718, and H. Frey et al., Chem. Eur. J., 2000, 6, No. 14, 2499. They include star polymers, dendrimers, structurally and molecularly nonuniform highly branched polymers, and high molecular mass branched polymers different than these, such as comb polymers. Star polymers are polymers in which three or more chains extend out from one center. The center may be a single atom or a group of atoms. Dendrimers (cascade polymers) are molecularly uniform polymers having a highly symmetrical structure. In structural terms they derive from star polymers, with their chains branching again in a starlike manner. Dendrimers are prepared from small molecules by means of repeated reaction sequences. The number of monomer end groups grows exponentially with each reaction step and results in a spherical, treelike structure. On account of their uniform structure, dendrimers possess a uniform molecular weight.

In the context of the present invention it is preferred to use highly branched polymers which are different than dendrimers, i.e., which are both structurally and molecularly nonuniform (and hence do not have a uniform molecular weight, instead having a molecular weight distribution). Depending on reaction regime, they may be constructed on the one hand starting from a central molecule, in the same way as dendrimers, but with a nonuniform branched chain length. On the other hand, they may also extend out from linear molecules and be constructed with branched functional side groups.

“Highly branched” for the purposes of the present invention means, furthermore, that the degree of branching (DB) is 10% to 99.9%, preferably 20% to 99%, and more particularly from 20% to 95%. The degree of branching is the average number of dendritic links plus the average number of end groups per molecule, divided by the sum of average number of dendritic links, average number of linear links, and average number of end groups, multiplied by 100. By “dendritic” in this context is meant that the degree of branching at this point in the molecule is 99.9 to 100%. For the definition of the degree of branching, refer also to H. Frey et al., Acta Polym. 1997, 48, 30.

The highly branched polymers used in accordance with the invention are substantially noncrosslinked. “Substantially noncrosslinked” or “noncrosslinked” in the sense of the present invention means that there is a degree of crosslinking of less than 15% by weight, preferably of less than 10% by weight, the degree of crosslinking being determined via the insoluble fraction of the polymer. The insoluble fraction of the polymer is determined, for example, by 4-hour extraction with the same solvent as used for the gel permeation chromatography (GPC), in other words preferably dimethylacetamide or hexafluoroisopropanol, depending on the solvent in which the polymer has the better solubility, in a Soxhlet apparatus, and by weighing the residue that remains after the extracted material has been dried to constant weight.

The highly branched polymers used in accordance with the invention preferably have a number-average molecular weight, Mₙ, of at least 500, as for example from 500 to 200 000 or preferably from 500 to 100 000 or more preferably from 500 to 50 000 or more preferably still from 500 to 30 000 or even more preferably from 500 to 20 000 or more particularly from 500 to 10 000; with particular preference, of at least 750, as for example from 750 to 200 000 or preferably from 750 to 100 000 or more preferably from 750 to 50 000 or more preferably still from 750 to 30 000 or even more preferably from 750 to 20 000 or more particularly from 750 to 10 000; and more particularly of at least 1000, as for example from 1000 to 200 000 or preferably from 1000 to 100 000 or more preferably from 1000 to 50 000 or more preferably still from 1000 to 30 000 or even more preferably from 1000 to 20 000 or more particularly from 1000 to 10 000.

The highly branched polymers used in accordance with the invention preferably have a weight-average molecular weight, M_{w}, of at least 1000, as for example from 1000 to 500 000 or preferably from 1000 to 200 000 or more preferably from 1000 to 100 000 or more preferably still from 1000 to 60 000 or even more preferably from 1000 to 40 000 or particularly from 1000 to 20 000; with particular preference, of at least 1500, as for example from 1500 to 500 000 or preferably from 1500 to 200 000 or more preferably from 1500 to 100 000 or more preferably still from 1500 to 60 000 or even more preferably from 1500 to 40 000 or more particularly from 1500 to 20 000; and more particularly of at least 2000, as for example from 2000 to 500 000 and preferably from 2000 to 200 000 or more preferably from 2000 to 100 000 or more preferably still from 2000 to 60 000 or even more preferably from 2000 to 40 000 or more particularly from 2000 to 20 000.

The polydispersity (PD=M_{w}/Mₙ) is preferably in the range from 1.0 to 30, more preferably from 1.3 to 20, more preferably still from 1.5 to 10, and more particularly from 1.5 to 5.

The figures given in the context of the present invention for molecular weights (Mₙ, M_{w}) and for the polydispersity refer to figures resulting from gel permeation chromatography (GPC) in a suitable solvent, such as hexafluoroisopropanol, tetrahydrofuran, N,N-dimethylacetamide or water, with PMMA calibration.

In contradistinction to the polymers the oligomeric compounds (v) and (vi) are low molecular mass products which are formed by the condensation of a few molecules, preferably 2, 3, 4 or 5 molecules, more preferably 2, 3 or 4 molecules, and have a defined molecular weight. For example, the oligomeric compounds (v) are formed by the condensation of a urea molecule or of a urea derivative with one or with two amine molecule(s). The oligomeric compounds (vi) come about, for example, through the condensation of a melamine molecule with one, two or three amine molecule(s).

Unless indicated otherwise, the following general definitions apply in the context of the present invention:

C₁-C₄-Alkyl stands for a linear or branched alkyl radical having 1 to 4 carbon atoms. These radicals are methyl, ethyl, n-propyl, isopropyl, n-butyl, sec-butyl, isobutyl, and tert-butyl.

Linear C₁-C₄-alkyl stands for a linear alkyl radical having 1 to 4 carbon atoms. These radicals are methyl, ethyl, n-propyl, and n-butyl.

C₂-C₆-Alkyl stands for a linear or branched alkyl radical having 2 to 6 carbon atoms. Examples are ethyl, n-propyl, isopropyl, n-butyl, sec-butyl, isobutyl, tert-butyl, pentyl, neopentyl, hexyl, and their constitutional isomers. In the amine II (see below) the C₂-C₆-alkyl radical carries three substituents, E₁-NHR^{d}, E₂-NHR^{e}, and E₃-NHR^{f}. Accordingly the C₂-C₆-alkyl in this case is a C₂-C₆-alkanetriyl radical. Examples are ethane-1,1,1-triyl, ethane-1,1,2-triyl, propane-1,1,1-triyl, propane-1,1,2-triyl, propane-1,1,3-triyl, propane-1,2,2-triyl, propane-1,2,3-triyl, butane-1,1,1-triyl, butane-1,1,2-triyl, butane-1,2,2-triyl, butane-1,1,3-triyl, butane-1,3,3-triyl, butane-1,1,4-triyl, butane-1,2,3-triyl, butane-1,2,4-triyl and the like. Only if the radicals E₁, E₂, and E₃ stand for C₁-C₁₀-alkylene can two or all three of the aforementioned radicals be attached to the same carbon atom of the alkanetriyl radical; otherwise they are attached preferably to different carbon atoms.

C₁-C₁₀-Alkyl stands for a linear or branched alkyl radical having 1 to 10 carbon atoms. Examples thereof are methyl, ethyl, n-propyl, isopropyl, n-butyl, sec-butyl, isobutyl, tert-butyl, pentyl, neopentyl, hexyl, heptyl, octyl, 2-ethylhexyl, nonyl, decyl, 2-propylheptyl, and their constitutional isomers.

C₁-C₁₂-Alkyl stands for a linear or branched alkyl radical having 1 to 12 carbon atoms. Examples thereof are methyl, ethyl, n-propyl, isopropyl, n-butyl, sec-butyl, isobutyl, tert-butyl, pentyl, neopentyl, hexyl, heptyl, octyl, 2-ethylhexyl, nonyl, decyl, 2-propylheptyl, 4-methyl-2-propylhexyl, undecyl, dodecyl, and their constitutional isomers.

C₁-C₂₀-Alkyl stands for a linear or branched alkyl radical having 1 to 20 carbon atoms. Examples thereof, in addition to the radicals stated for C₁-C₁₂-alkyl, are tridecyl, tetradecyl, pentadecyl, hexadecyl, heptadecyl, octadecyl, nonadecyl, eicosyl, and their constitutional isomers.

C₂-C₁₀-Alkenyl stands for a singly unsaturated aliphatic hydrocarbon radical having 2 to 10 carbon atoms. Examples thereof are ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl, 1-, 2- and 3-heptenyl, 1-, 2-, 3- and, 4-octenyl, 1-, 2-, 3-, and 4-nonenyl, and 1-, 2-, 3-, 4-, and 5-decenyl, and positional isomers thereof.

Aryl stands for a carbocyclic aromatic radical having 6 to 14 carbon atoms, such as phenyl, naphthyl, anthracenyl or phenanthrenyl. Preferably aryl stands for phenyl or naphthyl and more particularly for phenyl.

Aryl-C₁-C₄-alkyl stands for C₁-C₄-alkyl, which is as defined above, with one hydrogen atom replaced by an aryl group. Examples are benzyl, phenethyl, and the like.

C₁-C₄-Alkylene is a linear or branched divalent alkyl radical having 1, 2, 3 or 4 carbon atoms. Examples are —CH₂—, —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, and —CH₂CH₂CH₂CH₂CH₂—.

Linear or branched C₂-C₅-alkylene is a linear or branched divalent alkyl radical having 2, 3, 4 or 5 carbon atoms. Examples are —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, —CH₂C(CH₃)₂—, and —CH₂CH₂CH₂CH₂CH₂—.

Linear or branched C₂-C₆-alkylene is a linear or branched divalent alkyl radical having 2, 3, 4, 5 or 6 carbon atoms. Examples, in addition to the radicals stated above for C₂-C₅-alkylene, are —CH₂CH₂CH₂CH₂CH₂CH₂—.

Linear or branched C₄-C₈-alkylene is a linear or branched divalent alkyl radical having 4 to 8 carbon atoms. Examples are —CH₂CH₂CH₂CH₂—, —CH(CH₃)CH₂CH₂—, —CH₂CH₂CH(CH₃)—, —C(CH₃)₂CH₂—, —CH₂C(CH₃)₂—, —CH₂CH₂CH₂CH₂CH₂—, —CH₂C(CH₃)₂CH₂—, —CH₂CH₂CH₂CH₂CH₂CH₂—, —(CH₂)₇—, —(CH₂)₈—, and positional isomers thereof.

Linear or branched C₂-C₁₀-alkylene is a linear or branched divalent alkyl radical having 2 to 10 carbon atoms. Examples, in addition to the radicals stated above for C₂-C₅-alkylene, are the higher homologs with 6 to 10 carbon atoms, such as hexylene, heptylene, octylene, nonylene, and decylene.

Linear or branched C₁-C₁₀-alkylene is a linear or branched divalent alkyl radical having 1 to 10 carbon atoms. Examples, in addition to the radicals stated above for C₂-C₁₀-alkylene, are methylene (—CH₂—).

Linear or branched C₂-C₂₀-alkylene is a linear or branched divalent alkyl radical having 2 to 20 carbon atoms. Examples, in addition to the radicals stated above for C₂-C₅-alkylene, are the higher homologs having 6 to 20 carbon atoms, such as hexylene, heptylene, octylene, nonylene, decylene, undecylene, dodecylene, tridecylene, tetradecylene, pentadecylene, hexadecylene, heptadecylene, octadecylene, nonadecylene, and eicosylene.

Alkenylene is a linear or branched aliphatic, singly or multiply, e.g., singly or doubly, olefinically unsaturated divalent radical having for example 2 to 20 or 2 to 10 or 4 to 8 carbon atoms. If the radical contains more than one carbon-carbon double bond these bonds are preferably not vicinal, i.e., not allenic.

Alkynylene is a linear or branched aliphatic divalent radical having, for example, 2 to 20 or 2 to 10 or 4 to 8 carbon atoms and containing one or more, e.g., 1 or 2, carbon-carbon triple bonds.

C₅-C₈-Cycloalkylene stands for a divalent monocyclic, saturated hydrocarbon group having 5 to 8 carbon ring members. Examples are cyclopentane-1,2-diyl, cyclopentane-1,3-diyl, cyclohexane-1,2-diyl, cyclohexane-1,3-diyl, cyclohexane-1,4-diyl, cycloheptane-1,2-diyl, cycloheptane-1,3-diyl, cycloheptane-1,4-diyl, cyclooctane-1,2-diyl, cyclooctane-1,3-diyl, cyclooctane-1,4-diyl, and cyclooctane-1,5-diyl.

5- or 6-membered unsaturated nonaromatic heterocycle attached by N and possibly further comprising one or two further nitrogen atoms or one further sulfur atom or oxygen atom as ring member stands, for example, for pyrrolin-1-yl, pyrazolin-1-yl, imidazolin-1-yl, 2,3-dihydrooxazol-3-yl, 2,3- and 2,5-dihydroisoxazol-2-yl, 2,3-dihydrothiazol-3-yl, 2,3- and 2,5-dihydroisothiazol-2-yl, [1,2,3]-1H-triazolin-1-yl, [1,2,4]-1H-triazolin-1-yl, [1,3,4]-1H-triazolin-1-yl, [1,2,3]-2H-triazolin-2-yl, 1,2-dihydropyridin-1-yl, 1,4-dihydropyridin-1-yl, 1,2,3,4-tetrahydropyridin-1-yl, 1,2-dihydropyridazin-1-yl, 1,4-dihydropyridazin-1-yl, 1,6-dihydropyridazin-1-yl, 1,2,3,4-tetrahydropyridazin-1-yl, 1,4,5,6-tetrahydropyridazin-1-yl, 1,2-dihydropyrimidin-1-yl, 1,4-dihydropyrimidin-1-yl, 1,6-dihydropyrimidin-1-yl, 1,2,3,4-tetrahydropyrimidin-1-yl, 1,4,5,6-tetrahydropyrimidin-1-yl, 1,2-dihydropyrazin-1-yl, 1,4-dihydropyrazin-1-yl, 1,2,3,4-tetrahydropyrazin-1-yl, 1,4-oxazin-4-yl, 2,3-dihydro-1-4-oxazin-4-yl, 2,3,5,6-tetrahydro-1-4-oxazin-4-yl-1,4-thiazin-4-yl, 2,3-dihydro-1-4-thiazin-4-yl, 2,3,5,6-tetrahydro-1-4-thiazin-4-yl, 1,2-dihydro-1,3,5-triazin-1-yl, 1,2,3,4-tetrahydro-1,3,5-triazin-1-yl and the like.

5- or 6-membered unsaturated aromatic heterocycle attached via N and possibly further comprising a further nitrogen atom as ring member is 5-membered and stands, for example, for pyrrol-1-yl, pyrazol-1-yl, imidazolyl-1-yl, and triazol-1-yl.

5- or 6-membered saturated, partly unsaturated or aromatic heterocycle comprising 1, 2 or 3 heteroatoms, selected from N, O, and S, as ring member stands, for example, for 2-tetrahydrofuranyl, 3-tetrahydrofuranyl, 2-tetrahydrothienyl, 3-tetrahydrothienyl, 1-pyrrolidinyl, 2-pyrrolidinyl, 3-pyrrolidinyl, 2-isoxazolidinyl, 3-isoxazolidinyl, 4-isoxazolidinyl, 5-isoxazolidinyl, 2-isothiazolidinyl, 3-isothiazolidinyl, 4-isothiazolidinyl, 5-isothiazolidinyl, 1-pyrazolidinyl, 3-pyrazolidinyl, 4-pyrazolidinyl, 2-oxazolidinyl, 3-oxazolidinyl, 4-oxazolidinyl, 5-oxazolidinyl, 2-thiazolidinyl, 3-thiazolidinyl, 4-thiazolidinyl, 5-thiazolidinyl, 1-imidazolidinyl, 2-imidazolidinyl, 4-imidazolidinyl, 1,2,4-oxadiazolidin-3-yl, 1,2,4-oxadiazolidin-5-yl, 1,2,4-thiadiazolidin-3-yl, 1,2,4-thiadiazolidin-5-yl, 1,2,4-triazolidin-3-yl, 1,3,4-oxadiazolidin-2-yl, 1,3,4-thiadiazolidin-2-yl, 1,3,4-triazolidin-1-yl, 1,3,4-triazolidin-2-yl, 1,3,4-triazolidin-3-yl, 1,3,4-triazolidin-4-yl, 2,3-dihydrofur-2-yl, 2,3-dihydrofur-3-yl, 2,4-dihydrofur-2-yl, 2,4-dihydrofur-3-yl, 2,3-dihydrothien-2-yl, 2,3-dihydrothien-3-yl, 2,4-dihydrothien-2-yl, 2,4-dihydrothien-3-yl, 2-pyrrolin-2-yl, 2-pyrrolin-3-yl, 3-pyrrolin-2-yl, 3-pyrrolin-3-yl, 2-isoxazolin-3-yl, 3-isoxazolin-3-yl, 4-isoxazolin-3-yl, 2-isoxazolin-4-yl, 3-isoxazolin-4-yl, 4-isoxazolin-4-yl, 2-isoxazolin-5-yl, 3-isoxazolin-5-yl, 4-isoxazolin-5-yl, 2-isothiazolin-3-yl, 3-isothiazolin-3-yl, 4-isothiazolin-3-yl, 2-isothiazolin-4-yl, 3-isothiazolin-4-yl, 4-isothiazolin-4-yl, 2-isothiazolin-5-yl, 3-isothiazolin-5-yl, 4-isothiazolin-5-yl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydro-pyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 3,4-dihydrooxazol-5-yl, 3,4-dihydrooxazol-2-yl, 3,4-dihydrooxazol-3-yl, 3,4-dihydrooxazol-4-yl, 1-piperidinyl, 2-piperidinyl, 3-piperidinyl, 4-piperidinyl, 1,3-dioxan-5-yl, 2-tetrahydropyranyl, 4-tetrahydropyranyl, 2-tetrahydrothienyl, 3-hexahydropyridazinyl, 4-hexahydropyridazinyl, 2-hexahydropyrimidinyl, 4-hexahydropyrimidinyl, 5-hexahydropyrimidinyl, 2-piperazinyl, 1,3,5-hexahydro-triazin-2-yl, 1,2,4-hexahydrotriazin-3-yl, 2-furyl, 3-furyl, 2-thienyl, 3-thienyl, 1-pyrrolyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 1-pyrazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 1-imidazolyl, 2-imidazolyl, 4-imidazolylyl, 1,2,4-oxadiazol-3-yl, 1,2,4-oxadiazol-5-yl, 1,2,4-thiadiazol-3-yl, 1,2,4-thiadiazol-5-yl, 1,2,4-triazol-3-yl, 1,3,4-oxadiazol-2-yl, 1,3,4-thiadiazol-2-yl, and 1,3,4-triazol-2-yl; pyridin-2-yl, pyridin-3-yl, pyridin-4-yl, 3-pyridazinyl, 4-pyridazinyl, 2-pyrimidinyl, 4-pyrimidinyl, 5-pyrimidinyl, 2-pyrazinyl, 1,3,5-rriazin-2-yl, and 1,2,4-triazin-3-yl.

By a primary amino group is meant a radical —NH₂. By a secondary amino group is meant a radical —NHR, R being other than H.

The observations made above and below in relation to preferred embodiments of the inventive use, composition, and epoxy resins, more particularly on the condensation products employed in accordance with the invention and on their parent monomers and further reaction components, apply not only individually per se but also, more particularly, in any conceivable combination with one another.

The urea derivatives of components (i-1) and (v-1) are preferably selected from
substituted ureas of formula R¹R²N—C(═O)—NR³R⁴, in which R¹, R², R³, and R⁴ independently of one another are selected from hydrogen, C₁-C₁₂-alkyl, aryl, and aryl-C₁-C₄-alkyl, with at least one of the radicals R¹, R², R³, and R⁴ not being hydrogen;
or R¹ and R² and/or R³ and R⁴ each together are C₂-C₅-alkylene, with one methylene group (i.e., a CH₂ group in the alkylene chain) optionally being replaced by a carbonyl group;
or R¹ and R³ together are C₂-C₅-alkylene, with one methylene group (i.e., a CH₂ group in the alkylene chain) optionally being replaced by a carbonyl group;
or R¹ and R² and/or R³ and R⁴, in each case together with the nitrogen atom to which they are attached, form a 5- or 6-membered unsaturated aromatic or nonaromatic ring which may comprise one or two further nitrogen atoms or a sulfur atom or oxygen atom as ring member (i.e., R¹ and R², and/or R³ and R⁴, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member);
biuret
thiourea;
substituted thioureas of formula R⁵R⁶N—C(═S)—NR⁷R⁸, in which R⁵, R⁶, R⁷, and R⁸ independently of one another are selected from hydrogen, C₁-C₁₂-alkyl, aryl, and aryl-C₁-C₄-alkyl, with at least one of the radicals R⁵, R⁶, R⁷, and R⁸ not being hydrogen;
or R⁵ and R⁶ and/or R⁷ and R⁸ each together are C₂-C₅-alkylene, with one methylene group (i.e., a CH₂ group in the alkylene chain) optionally being replaced by a carbonyl group;
or R⁵ and R⁷ together are C₂-C₅-alkylene, with one methylene group (i.e., a CH₂ group in the alkylene chain) optionally being replaced by a carbonyl group; or R⁵ and R⁶ and/or R⁷ and R⁸, in each case together with the nitrogen atom to which they are attached, form a 5- or 6-membered unsaturated aromatic or nonaromatic ring which may comprise one or two further nitrogen atoms or a sulfur atom or oxygen atom as ring member (i.e., R⁵ and R⁶, and/or R⁷ and R⁸, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member);
guanidine;
substituted guanidines of the formula R⁹R¹⁰N—C(═NR¹¹)—NR¹²R¹³, in which R⁹, R¹⁰, R¹¹, R¹², and R¹³ independently of one another are selected from hydrogen, C₁-C₁₂-alkyl, aryl, and aryl-C₁-C₄-alkyl, with at least one of the radicals R⁹, R¹⁰, R¹¹, R¹², and R¹³ not being hydrogen;
or R⁹ and R¹⁰ and/or R¹² and R¹³ each together are C₂-C₅-alkylene, with one methylene group (i.e., a CH₂ group in the alkylene chain), optionally being replaced by a carbonyl group;
or R⁹ and R¹² together are C₂-C₅-alkylene, with one methylene group (i.e. a CH₂ group in the alkylene chain), optionally being replaced by a carbonyl group; or R⁹ and R¹⁰ and/or R¹² and R¹³, in each case together with the nitrogen atom to which they are attached, form a 5- or 6-membered unsaturated aromatic or nonaromatic ring which may further comprise one further nitrogen atom, sulfur atom or oxygen atom as ring member (i.e., R⁹ and R¹⁰, and/or R¹² and R¹³, together with the nitrogen atom to which they are attached, stand for a 5- or 6-membered unsaturated aromatic or nonaromatic ring which is attached via N and may comprise one or two further nitrogen atoms or one sulfur atom or oxygen atom as ring member); and
carbonic esters of the formula R¹⁴—O—CO—O—R¹⁵, in which R¹⁴ and R¹⁵ independently of one another are selected from C₁-C₁₂-alkyl, aryl, and aryl-C₁-C₄-alkyl, or R¹⁴ and R¹⁵ together are C₂-C₅-alkylene.

It is of course also possible to use mixtures of different urea derivatives.

In one preferred embodiment, in the substituted ureas, R² and R⁴ are hydrogen and R¹ and R³ are alike or different and are C₁-C₁₂-alkyl, aryl or aryl-C₁-C₄-alkyl. Examples thereof are N,N′-dimethylurea, N,N′-diethylurea, N,N′-dipropylurea, N,N′-diisopropyl-urea, N,N′-di-n-butylurea, N,N′-diisobutylurea, N,N′-di-sec-butylurea, N,N′-di-tert-butylurea, N,N′-dipentylurea, N,N′-dihexylurea, N,N′-diheptylurea, N,N′-dioctylurea, N,N′-didecylurea, N,N′-didodecylurea, N,N′-diphenylurea, N,N′-dinaphthylurea, N,N′-ditolylurea, N,N′-dibenzylurea, N-methyl-N′-phenylurea, and N-ethyl-N′-phenylurea.

In an alternatively preferred embodiment R¹, R², R³, and R⁴ are alike and are linear C₁-C₄-alkyl. Examples thereof are N,N,N′,N′-tetramethylurea and N,N,N′,N′-tetraethyl-urea.

In an alternatively preferred embodiment R¹ and R² and also R³ and R⁴ each together are C₂-C₅-alkylene, with one methylene group (CH₂) in the alkylene chain possibly being replaced by a carbonyl group (CO); that is, R¹ and R² together form a C₂-C₅-alkylene group in which a methylene group (CH₂) in the alkylene chain may be replaced by a carbonyl group (CO), and R³ and R⁴ together form a C₂-C₅-alkylene group in which a methylene group (CH₂) in the alkylene chain may be replaced by a carbonyl group (CO). Examples thereof are di(tetrahydro-1H-pyrrol-1-yl)methanone, bis(pentamethylene)urea and carbonylbiscaprolactam.

In an alternatively preferred embodiment R² and R⁴ are hydrogen and R¹ and R³ together form a C₂-C₅-alkylene group, with a methylene group possibly being replaced by a carbonyl group. Examples thereof are ethyleneurea and also 1,2- or 1,3-propyleneurea.

In an alternatively preferred embodiment R¹ and R² and also R³ and R⁴ each together with the nitrogen atom to which they are attached form an unsaturated aromatic or nonaromatic heterocycle as defined above. Examples thereof are carbonyldipyrazole and carbonyldiimidazole.

In one preferred embodiment, in the substituted thioureas, R⁶ and R⁸ are hydrogen and R⁵ and R⁷ are alike or different and are C₁-C₁₂-alkyl, aryl or aryl-C₁-C₄-alkyl. Examples thereof are N,N′-dimethylthiourea, N,N′-diethylthiourea, N,N′-dipropylthiourea, N,N′-diisopropylthiourea, N,N′-di-n-butylthiourea, N,N′-diisobutylthiourea, N,N′-di-sec-butylthiourea, N,N′-di-tert-butylthiourea, N,N′-dipentylthiourea, N,N′-dihexylthiourea, N,N′-diheptylthiourea, N,N′-dioctylthiourea, N,N′-didecylthiourea, N,N′-didodecylthio-urea, N,N′-diphenylthiourea, N,N′-dinaphthylthiourea, N,N′-ditolylthiourea, N,N′-dibenzylthiourea, N-methyl-N′-phenylthiourea, and N-ethyl-N′-phenylthiourea.

In an alternatively preferred embodiment R⁵, R⁶, R⁷, and R⁸ are alike and are linear C₁-C₄-alkyl. Examples thereof are N,N,N′,N′-tetramethylthiourea and N,N,N′,N′-tetra-ethylthiourea.

In an alternatively preferred embodiment R⁵ and R⁶ and also R⁷ and R⁸ each together are C₂-C₅-alkylene, with one methylene group (CH₂) in the alkylene chain possibly being replaced by a carbonyl group (CO); that is, R⁵ and R⁶ together form a C₂-C₅-alkylene group in which a methylene group (CH₂) in the alkylene chain may be replaced by a carbonyl group (CO), and R⁷ and R⁸ together form a C₂-C₅-alkylene group in which a methylene group (CH₂) in the alkylene chain may be replaced by a carbonyl group (CO). Examples thereof are di(tetrahydro-1H-pyrrol-1-yl)methanethione, bis(pentamethylene)thiourea and thiocarbonylbiscaprolactam.

In an alternatively preferred embodiment R⁶ and R⁸ are hydrogen and R⁵ and R⁷ together form a C₂-C₅-alkylene group, with a methylene group possibly being replaced by a thiocarbonyl group. Examples thereof are ethylenethiourea and also 1,2- or 1,3-propylenethiourea.

In an alternatively preferred embodiment R⁵ and R⁶ and also R⁷ and R⁸ each together with the nitrogen atom to which they are attached form an unsaturated aromatic or nonaromatic heterocycle as defined above. Examples thereof are thiocarbonyldipyrazole and thiocarbonyldiimidazole.

Guanidine can also be used in the form of a guanidine salt, such as guanidine nitrate or, more particularly, guanidine carbonate.

In one preferred embodiment, in the substituted guanidines, R¹⁰, R¹¹, and R¹³ are hydrogen and R⁹ and R¹² are alike or different and are C₁-C₁₂-alkyl, aryl or aryl-C₁-C₄-alkyl. Examples thereof are N,N′-dimethylguanidine, N,N′-diethylguanidine, N,N′-dipropylguanidine, N,N′-diisopropylguanidine, N,N′-di-n-butylguanidine, N,N′-diiso-butylguanidine, N,N′-di-sec-butylguanidine, N,N′-di-tert-butylguanidine, N,N′-dipentyl-guanidine, N,N′-dihexylguanidine, N,N′-diheptylguanidine, N,N′-dioctylguanidine, N,N′-didecylguanidine, N,N′-didodecylguanidine, N,N′-diphenylguanidine, N,N′-dinaphthyl-guanidine, N,N′-ditolylguanidine, N,N′-dibenzylguanidine, N-methyl-N′-phenylguanidine, and N-ethyl-N′-phenylguanidine.

In an alternatively preferred embodiment R⁹, R¹⁰, R¹², and R¹³ are alike and are linear C₁-C₄-alkyl and R¹¹ is H or methyl and more particularly H. Examples thereof are N,N,N′,N′-tetramethylguanidine and N,N,N′,N′-tetraethylguanidine.

In an alternatively preferred embodiment R⁹ and R¹⁰ and also R¹² and R¹³ each together are C₂-C₅-alkylene, with one methylene group (CH₂) possibly being replaced by a carbonyl group (CO); that is, R⁹ and R¹⁰ together form a C₂-C₅-alkylene group in which a methylene group (CH₂) may be replaced by a carbonyl group (CO), and R¹² and R¹³ together form a C₂-C₅-alkylene group in which a methylene group (CH₂) may be replaced by a carbonyl group (CO), and R¹¹ is H or methyl and more particularly H. Examples thereof are di(tetrahydro-1H-pyrrol-1-yl)imine, bis(pentamethylene)guanidine and iminobiscaprolactam.

In an alternatively preferred embodiment R¹⁰, R¹¹, and R¹³ are hydrogen and R⁹ and R¹² together form a C₂-C₅-alkylene group, with a methylene group optionally being replaced by a carbonyl group. Examples thereof are ethyleneguanidine and also 1,2- or 1,3-propyleneguanidine.

In an alternatively preferred embodiment R⁹ and R¹⁰ and also R¹² and R¹³ each together with the nitrogen atom to which they are attached form an unsaturated aromatic or nonaromatic heterocycle as defined above, and R¹¹ is H or methyl and more particularly H. Examples thereof are iminodipyrazole and iminodiimidazole.

In one preferred embodiment R¹⁴ and R¹⁵ are C₁-C₄-alkyl. With particular preference the two radicals are alike. Examples thereof are dimethyl carbonate, diethyl carbonate, dipropyl carbonate, diisopropyl carbonate, di-n-butyl carbonate, di-sec-butyl carbonate, diisobutyl carbonate, and di-tert-butyl carbonate. Of these, preference is given to dimethyl carbonate and diethyl carbonate.

In one alternatively preferred embodiment R¹⁴ and R¹⁵ together are C₂-C₅-alkylene and preferably C₂-C₃-alkylene. Examples of such carbonates are ethylene carbonate and also 1,2- and 1,3-propylene carbonate.

Preference among the urea derivatives stated above is given to the substituted ureas, thiourea, the substituted thioureas, guanidine, the substituted guanidines, and the carbonic esters. More strongly preferred are the substituted ureas, thiourea, guanidine, and the carbonic esters. Preference among these is given to thiourea, N,N′-dimethylurea, N,N′-diethylurea, N,N′-di-n-butylurea, N,N′-diisobutylurea, N,N,N′,N′-tetramethylurea, guanidine, in the form particularly of guanidine carbonate, dimethyl carbonate, diethyl carbonate, ethylene carbonate, and 1,2-propylene carbonate. Even more strongly preferred are the substituted ureas, thiourea, and the carbonic esters. Preference among these is given to thiourea, N,N′-dimethylurea, N,N′-diethylurea, N,N′-di-n-butylurea, N,N′-diisobutylurea, N,N,N′,N′-tetramethylurea, dimethyl carbonate, diethyl carbonate, ethylene carbonate, and 1,2-propylene carbonate. Particular preference is given to using as component (i-1) urea or a substituted urea of the formula R¹R²N—C(═O)—NR³R⁴ in which R¹, R², R³, and R⁴ independently of one another are as defined above. Preferably R¹ and R³ are H or C₁-C₄-alkyl, particularly methyl or ethyl, and R² and R⁴ are C₁-C₄-alkyl, especially methyl or ethyl. More particularly use is made as component (i-1) of urea itself, optionally in combination with one of the aforementioned urea derivatives, and especially just urea.

Alternatively, particular preference is given to using as component (i-1) a carbonic ester of the formula R¹⁴—O—CO—O—R¹⁵ in which R¹⁴ and R¹⁵ independently are as defined above. Preferably R¹⁴ and R¹⁵ are C₁-C₄-alkyl, especially methyl or ethyl.

Preference is given to using as component (v-1) urea or a substituted urea of the formula R¹R²N—C(═O)—NR³R⁴ in which R¹, R², R³, and R⁴ independently of one another are as defined above. Preferably R¹ and R³ are H or C₁-C₄-alkyl, particularly methyl or ethyl, and R² and R⁴ are C₁-C₄-alkyl, especially methyl or ethyl. More particularly preferably use is made as component (v-1) of urea itself, optionally in combination with one of the aforementioned urea derivatives, and more particularly just urea.

Suitable for contemplation as at least difunctional di- or polyisocyanates (iii-1) used for preparing highly branched polymers (iii) are the aliphatic, cycloaliphatic, araliphatic, and aromatic di- or polyisocyanates that are known from the prior art and are exemplified below. They include, preferably, 4,4′-diphenylmethane diisocyanate, the mixtures of monomeric diphenylmethane diisocyanates and oligomeric diphenylmethane diisocyanates (polymeric MDI), tetramethylene diisocyanate, tetramethylene diisocyanate trimers, hexamethylene diisocyanate, hexamethylene diisocyanate trimers, isophorone diisocyanate trimer, 4,4′-methylenebis(cyclohexyl) diisocyanate, xlylene diisocyanate, tetramethylxylylene diisocyanate, dodecyl diisocyanate, lysine alkyl ester diisocyanate, where alkyl stands for C₁-C₁₀-alkyl, 1,4-diisocyanatocyclohexane or 4-isocyanatomethyl-1,8-octamethylene diisocyanate.

Particular preference is given to di- or polyisocyanates which contain NCO groups of different reactivities. Mention may be made here of 2,4-tolylene diisocyanate (2,4-TDI), 2,4′-diphenylmethane diisocyanate (2,4′-MDI), triisocyanatotoluene, isophorone diisocyanate (IPDI), 2-butyl-2-ethylpentamethylene diisocyanate, 2,2,4- or 2,4,4-trimethyl-1,6-hexamethylene diisocyanate, 2-isocyanatopropylcyclohexyl isocyanate, 3(4)-isocyanatomethyl-1-methylcyclohexyl isocyanate, 1,4-diisocyanato-4-methylpentane, 2,4′-methylenebis(cyclohexyl) diisocyanate, and 4-methylcyclohexane 1,3-diisocyanate (H-TDI).

Suitability is possessed, furthermore, by di- or polyisocyanates whose NCO groups are to start with of equal reactivity but in which, by initial addition of a reactant to one NCO group, it is possible to induce a drop in reactivity in the case of the second NCO group. Examples of such are isocyanates whose NCO groups are coupled via a delocalized π-electron system, examples being 1,3- and 1,4-phenylene diisocyanate, 1,5-naphthylene diisocyanate, diphenyl diisocyanate, tolidine diisocyanate or 2,6-tolylene diisocyanate.

Additionally it is possible to use oligoisocyanates or polyisocyanates which can be prepared from the abovementioned di- or polyisocyanate or mixtures thereof by means of linking via urethane, allophanate, urea, biuret, uretdione, amide, isocyanurate, carbodiimide, uretonimine, oxadiazinetrione or iminooxadiazinedione structures.

One embodiment uses masked (blocked) di- or polyisocyanates as component (iii-1). In masked or blocked di- or polyisocyanates the isocyanate groups are reacted reversibly to form another functional group that under appropriate conditions can be converted back into the isocyanate group. Preferably the isocyanate group is reacted with an alcohol, preferably a monoalcohol, to form a urethane group. The alcohol is generally eliminated simply during the reaction of the blocked di- or polyisocyanate with the amine (iii-2). Blocking the isocyanate groups lowers the very high reactivity of the isocyanates and enables controlled reaction with the amine (iii-2) and hence controlled construction of polyureas.

A feature of other blocking reagents for NCO groups is that they ensure thermally reversible blocking of the isocyanate groups at temperatures of in general below 160° C. Blocking agents of this kind are generally used to modify isocyanates that find use in thermally curable one-component polyurethane systems. These blocking agents are described exhaustively for example, in Z. W. Wicks, Prog. Org. Coat. 3 (1975) 73-99 and Prog. Org. Coat. 9 (1981), 3-28, D. A. Wicks and Z. W. Wicks, Prog. Org. Coat. constituent (B) (1999), 148-172 and Prog. Org. Coat. 41 (2001), 1-83, and also in Houben-Weyl, Methoden der Organischen Chemie, Vol. XIV/2, 61 ff., Georg Thieme Verlag, Stuttgart 1963. Blocking agents of this kind are preferably selected from phenols, caprolactam, 1H-imidazole, 2-methylimidazole, 1,2,4-triazole, 3,5-dimethylpyrazole, dialkyl malonates, acetanilide, acetone oxime, and butanone oxime.

The at least one carboxylic acid having at least two carboxyl groups (iv-1) may comprise aliphatic, cycloaliphatic or aromatic dicarboxylic or tricarboxylic acids or polycarboxylic acid.

Examples of aliphatic dicarboxylic acids are oxalic acid, malonic acid, succinic acid, glutaric acid, adipic acid, pimelic acid, suberic acid, azelaic acid, sebacic acid, undecane-α,ω-dioic acid, and dodecane-am-dioic acid. Also part of this group are unsaturated aliphatic dicarboxylic acids such as maleic acid, fumaric acid, and sorbic acid.

Examples of cycloaliphatic dicarboxylic acids are cis- and trans-cyclohexane-1,2-dicarboxylic acid, cis- and trans-cyclohexane-1,3-dicarboxylic acid, cis- and trans-cyclopentane-1,4-dicarboxylic acid, and cis- and trans-cyclopentane-1,3-dicarboxylic acid.

Examples of aromatic dicarboxylic acids are phthalic acid, isophthalic acid, and terephthalic acid.

An example of an aliphatic tricarboxylic acid is aconitic acid (E-1,2,3-propenetri-carboxylic acid).

An example of a cycloaliphatic tricarboxylic acid is 1,3,5-cyclohexanetricarboxylic acid.

Examples of aromatic tricarboxylic acids are 1,2,4-benzenetricarboxylic acid and 1,3,5-benzenetricarboxylic acid.

Examples of carboxylic acids having more than three carboxyl groups are 1,2,4,5-benzenetetracarboxylic acid (pyromellitic acid), 1,2,3,4,5,6-benzenehexacarboxylic acid (mellitic acid), and low molecular mass polyacrylic acid or polymethacrylic acid.

The carboxylic acids may also carry one or more radicals selected from C₁-C₂₀-alkyl, C₃-C₆-cycloalkyl, C₂-C₁₀-alkenyl, and aryl. Examples thereof are 2-methylmalonic acid, 2-ethylmalonic acid, 2-phenylmalonic acid, 2-methylsuccinic acid, 2-ethylsuccinic acid, C₁₈-alkenylsuccinic acid, 2-phenylsuccinic acid, itaconic acid. and 3,3-dimethylglutaric acid.

The carboxylic acids can be used as they are or in the form of suitable derivatives. Suitable derivatives are the respective anhydrides and the mono-, di- or polyesters, preferably the mono-, di- or poly-C₁-C₄-alkyl esters, more particularly the mono-, di- or polymethyl or -ethyl esters, and also, furthermore, the mono-, di- or polyvinyl esters and mixed esters.

As component (iv-1) it is also possible to use mixtures of different carboxylic acids and/or different carboxylic acid derivatives.

As component (iv-1) it is preferred to use at least one dicarboxylic acid or at least one dicarboxylic acid derivative or a mixture thereof.

Preference among these is given to malonic acid, succinic acid, glutaric acid, adipic acid, 1,2-, 1,3- or 1,4-cyclohexanedicarboxylic acid, phthalic acid, isophthalic acid, terephthalic acid, and the monoalkyl and dialkyl esters, more particularly the mono- and di-C₁-C₄-alkyl esters, of the aforementioned acids. Said at least one amine having at least two primary and/or secondary amino groups, of components (i-2), (ii-1), (iii-2), (iv-2), (v-2), and (vi-2), is preferably selected from amines of the formula I

NHR^{a}-A-NHR^{b} (I)

in which
A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula

B—Xₘ—B—
in which
each X independently is O or NR^{c}, in which R^{c} is H, C₁-C₄-alkyl, C₂-C₄-hydroxyalkyl or C₁-C₄-alkoxy, and preferably is H, C₁-C₄-alkyl or C₁-C₄-alkoxy;
each B independently of one another is C₂-C₆-alkylene; and
m is a number from 1 to 100; preferably 1 to 80, and more particularly 1 to 20; and
R^{a} and R^{b} independently of one another are H, C₁-C₄-alkyl, C₂-C₄-hydroxyalkyl or C₁-C₄-alkoxy, and preferably are H, C₁-C₄-alkyl or C₁-C₄-alkoxy.

Also suitable are mixtures of these amines.

Divalent aliphatic radicals are those which contain no cycloaliphatic, aromatic or heterocyclic constituents. Examples are alkylene, alkenylene, and alkynylene radicals.

Divalent alicyclic radicals may contain one or more, e.g., one or two, alicyclic radicals; however, they contain no aromatic or heterocyclic constituents. The alicyclic radicals may be substituted by aliphatic radicals, but bonding sites for the NHR^{a}- and NHR^{b} groups are located on the alicyclic radical.

Divalent aliphatic-alicyclic radicals contain not only at least one divalent aliphatic radical but also at least one divalent alicyclic radical, the two bonding sites for the HR^{a} and NHR^{b} groups possibly being located either both on the alicyclic radical(s) or both on the aliphatic radical(s) or one on an aliphatic radical and the other on an alicyclic radical.

Divalent aromatic radicals may contain one or more, e.g., one or two, aromatic radicals; however, they contain no alicyclic or heterocyclic constituents. The aromatic radicals may be substituted by aliphatic radicals, but both bonding sites for the NHR^{a}- and NHR^{b} groups are located on the aromatic radical(s).

Divalent araliphatic radicals contain not only at least one divalent aliphatic radical but also at least one divalent aromatic radical, the two bonding sites for the NHR^{a} and NHR^{b} groups possibly being located either both on the aromatic radical(s) or both on the aliphatic radical(s) or one on an aliphatic radical and the other on an aromatic radical.

In one preferred embodiment the divalent aliphatic radical A is linear or branched C₂-C₂₀-alkylene, more preferably linear or branched C₂-C₁₀-alkylene, and more particularly linear or branched C₄-C₈-alkylene.

Examples of suitable amines in which the radical A has this definition (C₂-C₂₀-alkylene) are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylene-diamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, and 1,4-diamino-4-methylpentane, and the like.

Preferred among these are amines in which A is linear or branched C₂-C₁₀-alkylene, such as in 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, 2,2,4- or 2,4,4-trimethyl-1,6-hexamethylenediamine, 1,5-diamino-2-methylpentane, 1,4-diamino-4-methylpentan and the like.

Particularly preferred among these are amines in which A is linear or branched C₄-C₈-alkylene, such as in 2,2-dimethyl-1,3-propanediamine, 1,4-butylenediamine, 1,5-pentylenediamine, hexamethylenediamine, heptamethylenediamine, octamethylene-diamine, 1,5-diamino-2-methylpentane, 1,4-diamino-4-methylpentane, and the like. In one specific embodiment amines are used in which A is linear or branched C₄-C₈-alkylene, with not more than one branch extending from one carbon atom in the branched alkylene. Examples of such amines are 1,4-butylenediamine, 1,5-pentylenediamine, hexamethylenediamine, heptamethylenediamine, octamethylenediamine, and 1,5-diamino-2-methylpentane, i.e., the amines listed above as having particular preference, except for 2,2-dimethyl-1,3-propanediamine and 1,4-diamino-4-methylpentane. Even more specifically, amines are used in which A is linear C₄-C₈-alkylene, such as 1,4-butylenediamine, 1,5-pentylenediamine, hexamethylenediamine, heptamethylenediamine, and octamethylenediamine.

In one preferred embodiment the divalent alicyclic radicals A are selected from C₅-C₈-cycloalkylene, which may carry 1, 2, 3 or 4 C₁-C₄-alkyl radicals.

Examples of suitable amines in which the radical A has this definition are cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctane or 1,5-diaminocyclooctane. The amino groups (—NHR^{a} and —NHR^{b}) may be positioned cis or trans to one another.

In one preferred embodiment the divalent aliphatic-alicyclic radicals A are selected from C₅-C₈-cycloalkylene-C₁-C₄-alkylene, C₅-C₈-cycloalkylene-C₁-C₄-alkylene-C₅-C₈-cycloalkylene, and C₁-C₄-alkylene-C₅-C₈-cycloalkylene-C₁-C₄-alkylene, it being possible for the cycloalkylene radicals to carry 1, 2, 3 or 4 C₁-C₄-alkyl radicals.

Examples of suitable amines in which the radical A has this definition are diaminodicyclohexylmethane, isophoronediamine, bis(aminomethyl)cyclohexane, such as 1,1-bis(aminomethyl)cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like. The groups attached to the alicyclic radical may each adopt any desired relative position (cis/trans) to one another.

In one preferred embodiment the divalent aromatic radicals A are selected from phenylene, biphenylene, naphthylene, phenylene-sulfone-phenylene, and phenylene-carbonyl-phenylene, it being possible for the phenylene and naphthylene radicals to carry 1, 2, 3 or 4 C₁-C₄-alkyl radicals.

Examples of suitable amines in which the radical A has this definition are phenylene-diamine, such as o-, m-, and p-phenylenediamine, tolylenediamine, such as o-, m-, and p-tolylenediamine, xylylenediamine, naphthylenediamine, such as 1,2-, 1,3-1,4-, 1,5-, 1,8-, 2,3-, 2,6-, and 2,7-naphthylene, diaminodiphenyl sulfone, such as 2,2′-, 3,3′-, and 4,4′-diaminodiphenyl sulfone, and diaminobenzophenone, such as 2,2′-, 3,3′-, and 4,4′-diaminobenzophenone.

In one preferred embodiment the divalent araliphatic radicals A are selected from phenylene-C₁-C₄-alkylene and phenylene-C₁-C₄-alkylene-phenylene, it being possible for the phenylene radicals to carry 1, 2, 3 or 4 C₁-C₄-alkyl radicals.

Examples of suitable amines in which the radical A has this definition are diaminodiphenylmethane, such as 2,2′-, 3,3′-, and 4,4′-diaminodiphenylmethane, and the like.

In one preferred embodiment X is O. In this case m is preferably a number from 2 to 100, preferably 2 to 80, and more particularly 2 to 20, e.g., 2 to 10 or 2 to 6.

Examples of suitable amines in which the radical A has this definition are amine-terminated polyoxyalkylene polyols, examples being Jeffamines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

In an alternatively preferred embodiment X is NR^{c}. R^{c} here is preferably H or C₁-C₄-alkyl, more preferably H or methyl, and more particularly H. In this case B is more particularly C₂-C₃-alkylene, such as 1,2-ethylene, 1,2-propylene, and 1,3-propylene, and more particularly is 1,2-ethylene. In this case m is preferably a number from 1 to 10, more preferably from 1 to 6, and more particularly from 1 to 4.

Examples of suitable amines in which the radical A has this definition are diethylenetriamine, triethylenetetramine, tetraethylenepentamine, pentaethylene-hexamine, hexaethyleneheptamine, heptaethyleneoctamine, octaethylenenonamine, higher polyimines, bis(3-aminopropyl)amine, bis(3-aminopropyl)methylamine, and the like.

R^{a} and R^{b} are independently of one another preferably H or C₁-C₄-alkyl, more preferably H, methyl or ethyl, and more particularly H.

Owing to the higher reactivity of primary amino functions —NH₂ in condensation reactions, said at least one amine having at least two primary and/or secondary amino groups, of components (i-2), (ii-1), (iii-2), (iv-2), (v-2), and (vi-2), is preferably selected from amines having at least two primary amino groups.

Accordingly R^{a} and R^{b} in compounds I are preferably both H.

In one specific embodiment at least one diamine having exactly two primary amino groups is used as amine having at least two primary and/or secondary amino groups, of components (i-2), (ii-1), (iii-2), (iv-2), (v-2), and (vi-2). In other words, this amine, apart from the two primary amino functions, contains no further (primary, secondary and/or tertiary) amino groups.

Preferred diamines having two primary amino groups are those of the formula

NH₂-A-NH₂,

in which A is a divalent aliphatic, alicyclic, aliphatic-alicyclic, aromatic or araliphatic radical, it also being possible for the aforementioned radicals to be interrupted by a carbonyl group or by a sulfone group and/or to be substituted by 1, 2, 3 or 4 radicals selected from C₁-C₄-alkyl, the aforementioned radicals of course containing no amino groups; or is a divalent radical of the formula

B—Xₘ—B—

in which

### X is O;

B is C₂-C₆-alkylene; and
m is a number from 1 to 100, preferably 1 to 80, and more particularly 1 to 20.

Reference is hereby made to the above observations concerning suitable preferred aliphatic, alicyclic, aliphatic-alicyclic, aromatic or araliphatic radicals A and concerning divalent radicals of the formula B—Xₘ—B— in which X is O, and also to the associated preferred and suitable amines (all of the above-recited examples of amines in which A is a divalent aliphatic, alicyclic, aliphatic-alicyclic, aromatic or araliphatic radical or is a divalent radical of the formula B—Xₘ—B— in which X is O are primary diamines).

Particularly preferred diamines having two primary amino groups are those of the formula NH₂-A-NH₂ in which A is a divalent aliphatic radical and preferably is linear or branched C₂-C₂₀-alkylene. With regard to suitable and preferred amines having these features, reference is made to the observations above (all of the above-recited examples of amines in which A is a divalent aliphatic radical and is preferably linear or branched C₂-C₂₀-alkylene are primary diamines).

Alternatively particularly preferred diamines having two primary amino groups are those of the formula NH₂-A-NH₂ in which A is an aliphatic-alicyclic radical. With regard to suitable and preferred amines having these features, reference is made to the observations above (all of the above-recited examples of amines in which A is a divalent aliphatic-alicyclic radical are primary diamines). As primary diamine NH₂-A-NH₂ in which A is an aliphatic-alicyclic radical, specific use is made of isophoronediamine.

Said at least one amine having at least three primary and/or secondary amino groups, of components (i-2), (ii-1), (iii-2), (iv-2), and (v-2) is preferably selected from
amines of the formula I.a

NHR^{a1}-A¹-NHR^{b1} (I.a)

in which A¹ is a divalent radical of the formula

B¹—X¹ₘ—B¹—
in which
each X¹ independently is O or NR^{c1}, with at least one X¹ in the compound I.a being NR^{c1}, in which R^{c1} is H, C₁-C₄-alkyl, C₂-C₄-hydroxyalkyl or C₁-C₄-alkoxy, with at least one radical R^{c1} being H, and preferably being H, C₁-C₄-alkyl or C₁-C₄-alkoxy, with at least one radical R^{c1} being H;
each B¹ independently is C₂-C₆-alkylene; and
m¹ is a number from 1 to 20; and
R^{a1} and R^{b1} independently of one another are H, C₁-C₄-alkyl, C₂-C₄-hydroxyalkyl or C₁-C₄-alkoxy, and preferably H, C₁-C₄-alkyl or C₁-C₄-alkoxy;
   amines of the formula II

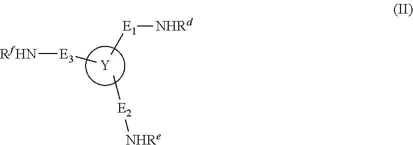

in which
Y is CR^{g}, N, C₂-C₆-alkyl, C₃-C₆-cycloalkyl, phenyl or a 5- or 6-membered, saturated, partly unsaturated or aromatic heterocyclic ring having 1, 2 or 3 heteroatoms as ring members which are selected from N, O, and S;
E₁, E₂, and E₃ independently of one another are a single bond, C₁-C₁₀-alkylene, —NR^{h}— C₂-C₁₀-alkylene or —O—C₁-C₁₀-alkylene, with the proviso that E₁, E₂, and E₃ are not a single bond and not —NR^{h}—C₂-C₁₀-alkylene if Y is N;
R^{d}, R^{e}, and R^{f} independently of one another are H, C₁-C₄-alkyl, C₂-C₄-hydroxyalkyl or C₁-C₄-alkoxy; and
R^{g} and R^{h} independently of one another are H, C₁-C₄-alkyl, C₂-C₄-hydroxyalkyl or C₁-C₄-alkoxy and preferably are H, C₁-C₄-alkyl or C₁-C₄-alkoxy;
   amines of the formula

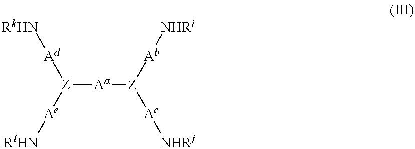

in which
A^{a} has one of the definitions stated for A;
A^{b}, A^{c}, A^{d}, and A^{e} independently of one another are C₁-C₁₀-alkylene;

### Z is N or CR^{m}; and

Rⁱ, R^{j}, R^{k}, R^{l}, and R^{m} independently of one another are H, C₁-C₄-alkyl, C₂-C₄-hydroxyalkyl or C₁-C₄-alkoxy and preferably are H, C₁-C₄-alkyl or C₁-C₄-alkoxy; and
   mixtures thereof.

In compounds La, preferably all radicals X¹ are NR^{c1}.

Subject to the above proviso, R^{c1} is preferably H or C₁-C₄-alkyl, more preferably H, methyl or ethyl, and more particularly H.

B¹ is preferably C₂-C₃-alkylene, such as 1,2-ethylene, 1,2-propylene, and 1,3-propylene, and more particularly 1,2-ethylene. Preferably m¹ is a number from 1 to 10, more preferably from 1 to 6, and more particularly from 1 to 4.

Examples of suitable amines of the formula I.a are diethylenetriamine, triethylenetetramine, tetraethylenepentamine, pentaethylenehexamine, hexaethyleneheptamine, heptaethyleneoctamine, octaethylenenonamine, higher polyimines, bis(3-aminopropyl)amine, bis(3-aminopropyl)methylamine, and the like.

In compounds II, where Y is N, E₁, E₂, and E₃ are not a single bond and not —NR^{h}—C₂-C₁₀-alkylene. Where Y is N, E₁, E₂, and E₃ are preferably also not methylene (C₁-alkylene). Where Y is CR^{g}, preferably at least two of the groups E₁, E₂, and E₃ are not a single bond.

Where Y is a 5- or 6-membered, saturated, partially unsaturated or aromatic heterocyclic ring, the three arms -E₁-NHR^{d}, -E₂-NHR^{e}, and -E₃-NHR^{f} may be attached both to carbon ring atoms and to nitrogen ring atoms of the heterocycle Y. Where the arms -E₁-NHR^{d}, -E₂-NHR^{e} and -E₃-NHR^{f} are bonded to ring nitrogen atoms, E₁, E₂ and E₃ are not a single bond and not —NR^{h}—C₂-C₁₀-alkylene. The arms are preferably attached to different ring atoms of the heterocycle Y. The heterocyclic ring Y is preferably selected from 5- or 6-membered heteroaromatic rings having 1, 2 or 3 nitrogen atoms as ring members. Examples of such hetaryl rings are pyrrolyl, pyrazolyl, imidazolylyl, pyridyl, pyrimidyl, pyrazinyl, pyridazonyl, and triazinyl. More preferred among these are 6-membered hetaryl rings, such as pyridyl, pyrimidyl, pyrazinyl, pyridazinyl, and triazinyl, with triazinyl being particularly preferred.

Where Y is a triazine ring, compound II is preferably melamine (Y=triazine-2,4,6-triyl; E₁, E₂, and E₃=single bond; R^{d}, R^{e}, and R^{f}═H) or is aminoalkyl-substituted melamine (Y=1,3,5-triazine-2,4,6-triyl; E₁, E₂, and E₃=NR^{h}—C₂-C₁₀-alkylene, preferably NR^{h}—C₂-C₆-alkylene, with R^{h} preferably being H; R^{d}, R^{e}, R^{f}=preferably H), such as N,N′,N″-tris(2-aminoethyl)melamine, N,N′,N″-tris(3-aminopropyl)melamine, N,N,N′,N″-tris(4-aminobutyl)melamine, N,N′,N″-tris(5-aminopentyl)melamine, and N,N′,N″-tris(6-aminohexyl)melamine.

The compounds III are amines having at least four primary and/or secondary amino functions.

In compounds III A^{a} preferably has one of the definitions stated as being preferred for A. More particularly A^{a} is C₂-C₆-alkylene, more preferably linear C₂-C₆-alkylene, such as 1,2-ethylene, 1,3-propylene, 1,4-butylene, pentamethylene, and hexamethylene.

Z is preferably N.

A^{b}, A^{c}, A^{d}, and A^{e} are preferably C₂-Cₛ-alkylene, more preferably linear C₂-C₆-alkylene, such as 1,2-ethylene, 1,3-propylene, 1,4-butylene, pentamethylene, and hexamethylene, and more particularly linear C₂-C₄-alkylene, such as 1,2-ethylene 1,3-propylene, and 1,4-butylene.

Rⁱ, R^{j}, R^{k}, R^{l}, and R^{m} are preferably H.

Examples of amines having three primary and/or secondary amino groups, of the formulae I.a, II, and III, are diethyleneamine, triethylenetetramine, tetraethylene-pentamine, pentaethylenehexamine, hexaethyleneheptamine, heptaethyleneoctamine, octaethylenenonamine, higher polyimines, e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine, trifunctional or higher polyfunctional amine-terminated polyoxyalkylene polyols (e.g., Jeffamines, examples being polyetheramine T403 or polyetheramine T5000) having a molecular weight of preferably 300 to 10 000, melamine, aminoalkyl-substituted melamines, such as N,N′,N″-tris(2-aminoethyl)melamine, N,N′,N″-tris(3-aminopropyl)melamine, N,N′,N″-tris(4-aminobutyl)melamine, N,N′,N″-tris(5-aminopentyl)melamine, and N,N′,N″-tris(6-aminohexyl)melamine, oligomeric diaminodiphenylmethanes (polymeric MDA).

Particularly preferred amines having at least three primary and/or secondary amino groups are selected from amines of the formula I.a and amines of the formula II.

Preferred amines of the formula I.a are diethylenetriamine, triethylenetetramine, tetraethylenepentamine, pentaethylenehexamine, hexaethyleneheptamine, heptaethyleneoctamine, octaethylenenonamine, higher polyimines, e.g., polyethylene-imines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N′,N-bis(3-aminopropyl)ethylenediamine, N,N′-bis(3-aminopropyl)propane-1,3-diamine, and N,N′-bis(3-aminopropyl)butane-1,4-diamine.

Preferred amines of the formula II are those in which Y is N or is a 1,3,5-triazine-2,4,6-triyl ring.

Preferred amines II in which Y is N are selected from N,N-bis(3-aminopropyl)-ethylenediamine, N,N-bis(3-aminopropyl)propane-1,3-diamine, N,N-bis(3-aminopropyl)-butane-1,4-diamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine.

Preferred amines II in which Y is a 1,3,5-triazine-2,4,6-triyl ring are melamine and aminoalkyl-substituted melamines, such as N,N′,N″-tris(2-aminoethyl)melamine, N,N′,N″-tris(3-aminopropyl)melamine, N,N′,N″-tris(4-aminobutyl)melamine, N,N′,N″-tris(5-aminopentyl)melamine, and N,N′,N″-tris(6-aminohexyl)melamine.

Owing to the higher reactivity of primary amino functions —NH₂ in condensation reactions, said at least one amine having at least three primary and/or secondary amino groups, of components (i-2), (ii-1), (iii-2), (iv-2), and (v-2), is preferably selected from amines having at least three primary amino groups. Accordingly, in compounds I.a, the radicals R^{a1}, R^{b1}, and R^{c1} are preferably H, and likewise, in compounds II, the radicals R^{d}, R^{e}, and R^{f} are preferably H. Analogously, in compounds III, the radicals Rⁱ, R^{j}, R^{k}, and R^{l}, are preferably H. With regard to suitable and preferred amines having at least three primary amino groups, reference is made to the observations above (all of the aforementioned examples are amines having at least three primary amino groups).

### (i) Highly Branched Polymer (i)

The highly branched polymers (i) are prepared using components (i-1) and (i-2) in a molar ratio of preferably 50:1 to 1:50, more preferably 20:1 to 1:20, more preferably still 10:1 to 1:10, even more preferably 5:1 to 1:15, more particularly 2:1 to 1:15, and especially 1.5:1 to 1:10.

Where component (i-2) comprises amines having two primary and/or secondary amino groups, the molar ratio of said at least one amine having at least three primary and/or secondary amino groups to the amine(s) having two primary and/or secondary amino groups is preferably 100:1 to 1:20, more preferably 50:1 to 1:10, and more particularly 25:1 to 1:10.

In component (i-2), in one preferred embodiment of the invention, said at least one amine having at least three primary and/or secondary amino groups comprises melamine. Besides melamine, however, component (i-2) may also comprise further, non-melamine amines having at least three primary and/or secondary amino groups.

In one particularly preferred embodiment (embodiment i-A) of the invention the highly branched polymers (i) are obtainable by condensation of

(i-1) urea or at least one urea derivative;
(i-2a) melamine;
(i-2b) at least one amine having at least two primary and/or secondary amino groups which is different than melamine, preferably having at least two primary amino groups, more preferably having two primary amino groups; and
(i-2c) optionally at least one melamine derivative selected from benzoguanamine, substituted melamines, and melamine condensates.

In a more strongly preferred embodiment (embodiment i-Aa) of the invention the highly branched polymers (i) are obtainable by condensation of

(i-1) urea or at least one urea derivative;
(i-2a) melamine;
(i-2b) at least one amine, with the at least one amine comprising
   (i-2ba) 20 to 100 mol %, based on the total amount of components (i-2ba), (i-2bb), and (i-2bc), of at least one diamine or polyamine having two primary amino groups,
   (i-2bb) 0 to 50 mol %, based on the total amount of components (i-2ba), (i-2bb), and (i-2bc), of at least one polyamine having at least three primary amino groups and being different than melamine; and
   (i-2bc) 0 to 80 mol %, based on the total amount of components (i-2ba), (i-2bb), and (i-2bc), of at least one amine having one primary amino group; and
(i-2c) optionally at least one melamine derivative selected from benzoguanamine, substituted melamines, and melamine condensates.

With regard to suitable and preferred urea derivatives, reference is made to the observations above. It is preferred as component (i-1) to use urea or a substituted urea of the formula R¹R²N—C(═O)—NR³R⁴ in which R¹, R², R³, and R⁴ independently of one another are as defined above. Preferably R¹ and R³ are H or C₁-C₄-alkyl, particularly methyl or ethyl, and R² and R⁴ are C₁-C₄-alkyl, especially methyl or ethyl. Particular preference is given to using as component (i-1), however, urea itself, optionally in combination with one of the aforementioned urea derivatives, and more particularly just urea.

The molar ratio of component (i-1) to component (i-2a) is preferably 50:1 to 1:50, more preferably 10:1 to 1:10, even more preferably 8:1 to 1:8, more preferably still 4:1 to 1:8, more particularly 2:1 to 1:5, and especially 1:1 to 1:5.

The molar ratio of component (i-1) to component (i-2b) is preferably 10:1 to 1:50, more preferably 2:1 to 1:50, even more preferably 2:1 to 1:25, more preferably still 1:1 to 1:20, more particularly 1:2.5 to 1:15, and especially 1:5 to 1:15.

With particular preference components (i-1), (i-2a), and (i-2b) are used in molar proportions such that the following is true: The ratio of

$$[ \frac{\begin{matrix}amount of component \\ ( i - 1 ) [ mol ]\end{matrix}}{2} + \frac{ \begin{matrix}amount of component \\ ( i - 2 a ) [ mol ]\end{matrix} }{3} ] : \\ amount of component ( i - 2 b ) [ mol ]$$

is preferably in the range from 0.05:1 to 0.75:1, more preferably from 0.075:1 to 0.5:1, and more particularly from 0.1:1 to 0.4:1.

The molar ratio of components (i-1) and (i-2a) is preferably within the ranges indicated above.

If component (i-2c) is inserted into the process of the invention, it preferably replaces a portion of component (i-1). It is preferably used in amounts such that it replaces 1 to 75 mol %, more preferably 1 to 50 mol %, and more particularly 1 to 25 mol % of component (i-1).

In embodiment (1-Aa) said at least one amine (i-2b) is preferably composed exclusively of components (i-2ba), (i-2bb), and (i-2bc); in other words, the fractions of these three components add up to 100 mol % of component (i-2b).

Component (i-2ba) is used preferably in an amount of 30 to 100 mol %, more preferably from 50 to 100 mol %, and more particularly from 75 to 100 mol %, based on the total amount of components (i-2ba), (i-2bb), and (i-2bc).

Component (i-2bb) is used in an amount of preferably 0 to 40 mol %, more preferably 0 to 30 mol %, and more particularly from 0 to 15 mol %, based on the total amount of components (i-2ba), (i-2bb), and (i-2bc).

Component (i-2bc) is used in an amount of preferably 0 to 70 mol %, more preferably 0 to 50 mol %, and more particularly from 0 to 25 mol %, based on the total amount of components (i-2ba), (i-2bb), and (i-2bc).

If component (i-2bb) is used, the amount in which it is used is preferably 1 to 50 mol %, e.g., 5 to 50 mol % or 10 to 50 mol %, more preferably 1 to 40 mol %, e.g., 5 to 40 mol % or 10 to 40 mol %, more preferably still 1 to 30 mol %, e.g., 5 to 30 mol % or 10 to 30 mol %, and more particularly 1 to 15 mol %, e.g., 2 to 15 mol % or 5 to 15 mol %, based on the total amount of components (i-2ba), (i-2bb), and (i-2bc).

If component (i-2bc) is used, the amount in which it is used is preferably 1 to 80 mol %, e.g., 5 to 80 mol % or 10 to 80 mol %, more preferably 1 to 70 mol %, e.g., 5 to 70 mol % or 10 to 70 mol %, more preferably still 1 to 50 mol %, e.g., 5 to 50 mol % or 10 to 50 mol %, and more particularly 1 to 25 mol %, e.g., 5 to 25 mol % or 10 to 25 mol %, based on the total amount of components (i-2ba), (i-2bb), and (i-2bc).

Component (i-2ba) comprises exactly two primary amino groups (—NH₂).

If component (1-2ba) comprises a polyamine, said polyamine comprises two primary amino groups (—NH₂) and additionally one or more secondary (—NHR; R not H) and/or tertiary (—NRR′; R and R′ not H) amino groups, e.g., 1 to 20 or 1 to 10 or 1 to 4 secondary and/or tertiary amino groups.

Where component (i-2ba) is a diamine, it comprises, apart from the two primary amino groups, no further amino functions.

The diamine or polyamine of component (i-2ba) in embodiment (1-Aa), and component (i-2b) in embodiment (i-A), is preferably selected from amines of the formula

NH₂-A-NH₂

in which A is as defined above.

Also suitable are mixtures of these amines.

As component (i-2ba) in embodiment (i-Aa) and as component (i-2b) in embodiment (i-A) it is preferred to use at least one diamine having two primary amino groups. Correspondingly said at least one amine (i-2ba) or (i-2b) contains, apart from the two primary amino functions, no further (primary, secondary and/or tertiary) amino groups.

Preferred diamines having two primary amino groups are those of the formula NH₂-A-NH₂ in which A is a divalent aliphatic, alicyclic, aliphatic-alicyclic, aromatic or araliphatic radical, it also being possible for the aforementioned radicals to be interrupted by a carbonyl group or by a sulfone group and/or to be substituted by 1, 2, 3 or 4 radicals selected from C₁-C₄-alkyl, the aforementioned radicals of course containing no amino groups; or is a divalent radical of the formula

B—Xₘ—B—

in which

### X is O;

B is C₂-C₆-alkylene; and
m is a number from 1 to 100, preferably 1 to 80, and more preferably 1 to 20.

Reference is hereby made to the previous observations concerning suitable and preferred aliphatic, alicyclic, aliphatic-alicyclic, aromatic or araliphatic radicals and concerning divalent radicals of the formula B—Xₘ—B— in which X is O, and also to the associated preferred and suitable amines.

Particularly preferred diamines having two primary amino groups are those of the formula NH₂-A-NH₂ in which A is a divalent aliphatic radical and preferably is linear or branched C₂-C₂₀-alkylene. Examples of suitable amines in which the radical A has this definition (C₂-C₂₀-alkylene) are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylene-diamine, octadecamethylenediamine, nonadecamethylenediamine, eicosamethylene-diamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like.

With particular preference A in the diamines having two primary amino groups is linear or branched C₂-C₁₀-alkylene. Examples of suitable amines in which the radical A has this definition (C₂-C₁₀-alkylene) are 1,2-ethylenediamine, 1,2- and 1,3-propylenediamine, 2,2-dimethyl-1,3-propanediamine, 1,4-butylenediamine, 1,5-pentylene-diamine, hexamethylenediamine, heptamethylenediamine, octamethylenediamine, nonamethylenediamine, decamethylenediamine, 2,2,4- or 2,4,4-trimethyl-1,6-hexamethylenediamine, 1,5-diamino-2-methylpentane, 1,4-diamino-4-methylpentane, and the like.

More particularly A in the diamines having two primary amino groups is linear or branched C₄-C₈-alkylene. Examples of suitable amines in which the radical A has this definition (C₄-C₈-alkylene) are 2,2-dimethyl-1,3-propanediamine, 1,4-butylenediamine, 1,5-pentylenediamine, hexamethylenediamine, heptamethylenediamine, octa-methylenediamine, 1,5-diamino-2-methylpentane, 1,4-diamino-4-methylpentane, and the like. In one specific embodiment amines are used in which A is linear or branched C₄-C₈-alkylene, not more than one branch extending from one carbon atom in the branched alkylene. Examples of such amines are 1,4-butylenediamine, 1,5-pentylene-diamine, hexamethylenediamine, heptamethylenediamine, octamethylenediamine, and 1,5-diamino-2-methylpentane, i.e., the amines recited above as being of particular preference, except for 2,2-dimethyl-1,3-propanediamine and 1,4-diamino-4-methyl-pentane. More strongly preferred among these are amines in which A is linear C₄-C₈-alkylene, such as in 1,4-butylenediamine, 1,5-pentylenediamine, hexamethylene-diamine, heptamethylenediamine and octamethylenediamine. The diamine having two primary amino groups is especially hexamethylenediamine.

In the embodiments (i-A) and (i-Aa) it is possible optionally to insert a polyamine having at least three primary amino groups which is not melamine (component i-2bb in embodiment (i-Aa) or subcomponent (i-2b) in embodiment (i-A)).

This component (i-2bb) or subcomponent (i-2b) comprises three or more primary amino groups and may further comprise one or more secondary and/or tertiary amino groups.

Using this polyamine component (i-2bb) or subcomponent (i-2b) makes sense in particular when a higher degree of branching of polymers is to be set than is possible solely with the diamine or polyamine (i-2ba) or (i-2b) in combination with melamine, since polyamines having at least three primary amino groups open up further branching opportunities in addition to the melamine (i-2a) used mandatorily in embodiment i-A or i-Aa. The secondary and/or tertiary amino groups present in the polyamine (i-2ba) are less reactive than the primary amino groups, and, under the typical condensation conditions, are capable usually to a low extent, if at all, of undergoing condensation and hence forming a branching site. At any rate they are substantially less capable than component (i-2bb) of forming branching sites.

With regard to suitable polyamines having at least three primary amino groups, reference is made to the observations above, albeit with the proviso that the compound in question is not melamine, since melamine indeed forms the mandatory component (i-2a).

If, conversely, the degree of branching is to be lower, it is appropriate to use at least one amine having one primary amino group (components i-2bc in embodiment i-Aa).

This component is an amine having a single primary amino function and optionally one or more secondary and/or tertiary amino groups.

Examples of primary amines without further secondary/tertiary amino functions (primary monoamines) are compounds of the formula R—NH₂ in which R is an aliphatic, alicyclic, aliphatic-alicyclic, aromatic or araliphatic radical which of course contains no amino groups.

Examples thereof are methylamine, ethylamine, propylamine, isopropylamine, n-butyl-amine, sec-butylamine, isobutylamine, tert-butylamine, pentylamine, hexylamine, ethanolamine, propanolamine, isopropanolamine, pentanolamine, (2-methoxyethyl)-amine, (2-ethoxyethyl)amine, (3-methoxypropyl)amine, (3-ethoxypropyl)amine, [3-(2-ethylhexyl)propyl]amine, 2-(2-aminoethoxy)ethanol, cyclohexylamine, aminomethylcyclohexane, aniline, benzylamine, and the like.

Examples of primary amines having one or more secondary and/or tertiary amino functions (polyamines having a (single) primary amino group) are N-methylethylene-1,2-diamine, N,N-dimethylethylene-1,2-diamine, N-ethylethylene-1,2-diamine, N,N-diethylethylene-1,2-diamine, N-methylpropylene-1,3-diamine, N,N-dimethylpropylene-1,3-diamine, N-ethylpropylene-1,3-diamine, N,N-diethylpropylene-1,3-diamine, N-methylbutylene-1,4-diamine, N,N-dimethylbutylene-1,4-diamine, N-methylpentylene-1,5-diamine, N,N-dimethylpentylene-1,5-diamine, N-methylhexylene-1,6-diamine, N,N-dimethylhexylene-1,6-diamine, N-methyldiethylenetriamine, N,N-dimethyl-diethylenetriamine, N-methyltriethylenetetramine, N,N-dimethyltriethylenetetramine, N-methyltetraethylenepentamine, N,N-dimethyltetraethylenepentamine, (3-(methylamino)-propyl)-(3-aminopropyl)amine, (3-(dimethylamino)propyl)-(3-aminopropyl)amine, (2-aminoethyl)ethanolamine, N-(2-hydroxyethyl)-1,3-propanediamine, N-methyl-diaminocyclohexane, N,N-dimethyldiaminocyclohexane, N-methylphenylenediamine, and the like.

As component (i-2bc) it is preferred to use primary monoamines, i.e., amines having a single primary amino group and without further secondary or tertiary amino functions.

In one particular version of embodiments i-A and i-Aa at least one melamine derivative is used as a further reactant (component i-2c).

The melamine derivative is preferably selected from benzoguanamine, substituted melamines, and melamine condensates.

The melamine condensates are preferably selected from melam, melem, melon, and higher condensates. Melam (empirical formula C₆—H₉N₁₁) is a dimeric condensation product of 2,4-diamino-6-chloro-s-triazine with melamine. Melem (empirical formula C₆H₆N₁₀) is the tri-amino-substituted tri-s-triazine (1,3,4,6,7,9,9b-heptaazaphenalene). Melon (empirical formula C₆H₃N₉) is likewise a heptazine. In an alternatively particularly preferred embodiment (embodiment i-B) the highly branched polymer (i) is obtainable by condensation of

(i-1) urea or at least one urea derivative;
(i-2d) at least one amine having at least three primary and/or secondary amino groups which is different than melamine; and
(i-2e) optionally at least one amine having two primary and/or secondary amino groups.

As component (i-1) it is preferred to use urea or a substituted urea of the formula R¹R²N—C(═O)—NR³R⁴ in which R¹, R², R³, and R⁴ independently of one another are as defined above, with preferably R¹ and R³ being H or C₁-C₄-alkyl, especially methyl or ethyl, and R² and R⁴ being C₁-C₄-alkyl, especially methyl or ethyl. As component (i-1) it is particularly preferred to use urea itself, optionally in combination with one of the aforementioned urea derivatives, and more particularly just urea.

Alternative preference is given to using as component (i-1) a carbonic ester of the formula R¹⁴—O—CO—O—R¹⁵ in which R¹⁴ and R¹⁵ independently are as defined above. Preferably R¹⁴ and R¹⁵ are C₁-C₄-alkyl, especially methyl or ethyl.

Alternatively preference is given to using as component (i-1) guanidine or a substituted guanidine of the formula R⁹R¹⁰N—C(═NR¹¹)—NR¹²R¹³ in which R⁹, R¹⁰, R¹¹, R¹², and R¹³ independently are as defined above. Preferably at least one of the radicals R⁹, R¹⁰, R¹¹, R¹², and R¹³ is not H but is instead C₁-C₄-alkyl, especially methyl or ethyl, and the other radicals are H or are C₁-C₄-alkyl, especially methyl or ethyl.

With regard to the at least one amine (i-2d) having at least three primary and/or secondary amino groups which is different than melamine, reference is made to the observations above, albeit with the proviso that the amine is not melamine.

Preference is given to amines of the formula I.a and amines of the formula II in which Y is N. In amines of the formula I.a A¹ is preferably a radical B¹—X¹ₘ₁— in which X¹ is NR^{c1} and R^{c1} is H. With particular preference R^{a1} and R^{b1} as well are H.

The amine (i-2e) having two primary and/or secondary amino groups is preferably selected from amines of the formula I.b

NHR^{a1}-A²-NHR^{b2} (I.b)

in which
A² is a divalent aliphatic, alicyclic, aliphatic-alicyclic, aromatic or araliphatic radical as defined above, it also being possible for the aforementioned radicals to be interrupted by a carbonyl group or by a sulfone group and/or to be substituted by 1, 2, 3 or 4 radicals selected from C₁-C₄-alkyl; or is a divalent radical of the formula

B²—X²ₘ₂—B²—
in which
each X² independently is O or NR^{c2}, in which R^{c2} is C₁-C₄-alkyl, C₂-C₄-hydroxyalkyl or C₁-C₄-alkoxy;
each B² independently is C₂-C₆-alkylene; and
m² is a number from 1 to 100, preferably 1 to 80, and more particularly 1 to 20; and
R^{a2} and R^{b2} independently of one another are H, C₁-C₄-alkyl, C₂-C₄-hydroxyalkyl or C₁-C₄-alkoxy.

Examples of such amines I.b having two primary and/or secondary amino groups are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like, N-methylethylenediamine, N,N′-dimethylethylenediamine, N-ethylethylenediamine, N,N′-diethylethylenediamine, N-propylethylenediamine, N,N′-dipropylethylenediamine, N-methylpropylenediamine, N,N′-dimethylpropylenediamine, N-ethylpropylenediamine, N,N′-diethylpropylenediamine, N-propylpropylenediamine, N,N′-dipropylpropylenediamine, N-methylbutylenediamine, N,N′-dimethylbutylenediamine, N-ethylbutylenediamine, N,N′-diethylbutylenediamine, bis(2-aminoethyl)methylamine, bis(2-aminoethyl)ethylamine, bis(2-aminoethyl)propylamine, bis(3-aminopropyl)methylamine, bis(3-aminopropyl)ethylamine, bis(3-aminopropyl)propylamine, and the like, additionally cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctane or 1,5-diaminocyclooctane, additionally diaminodicyclohexylmethane, isophoronediamine, bis(aminomethyl)-cyclohexane, such as 1,1-bis(aminomethyl)cyclohexane, 1,2-bis(aminomethyl)-cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like, additionally phenylenediamine, such as o-, m-, and p-phenylenediamine, tolylenediamine, such as o-, m-, and p-tolylenediamine, xylylenediamine, naphthylenediamine, such as 1,2-, 1,3-, 1,4-, 1,5-, 1,8-, 2,3-, 2,6- and 2,7-naphthylene, diaminodiphenyl sulfone, such as 2,2′-, 3,3′-, and 4,4′-diaminodiphenyl sulfone, and diaminobenzophenone, such as 2,2′-, 3,3′-, and 4,4′-diaminobenzophenone, and additionally diaminodiphenylmethane, such as 2,2′-, 3,3′-, and 4,4′-diaminodiphenyl, amine-terminated polyoxyalkylene polyols, examples being Jeff-amines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

Preference among these is given to amines having two primary amino groups, such as 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like, additionally cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctane or 1,5-diaminocyclooctane, and also diaminodicyclohexylmethane, isophoronediamine, bis(aminomethyl)cyclohexane such as 1,1-bis(aminomethyl)cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like, and also phenylenediamine, such as o-, m- and p-phenylenediamine, tolylendiamine, such as o-, m- and p-tolylenediamine, xylylenediamine, naphthylenediamine, such as 1,2-, 1,3-, 1,4-, 1,5-, 1,8-, 2,3-, 2,6-, and 2,7-naphthylene, diaminodiphenyl sulfone, such as 2,2′-, 3,3′-, and 4,4′-diaminodiphenyl sulfone, and diaminobenzophenone, such as 2,2′-, 3,3′-, and 4,4′-diaminobenzophenone, and also diaminodiphenylmethane, such as 2,2′-, 3,3′-, and 4,4′-diaminodiphenyl, amine-terminated polyoxyalkylene polyols, for example Jeff-amines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

Preferably A² is a divalent aliphatic, alicyclic, aliphatic-alicyclic, aromatic or araliphatic radical as defined above, it also being possible for the aforementioned radicals to be interrupted by a carbonyl group or by a sulfone group and/or to be substituted by 1, 2, 3 or 4 radicals selected from C₁-C₄-alkyl. Preference is given accordingly to diamines having two primary and/or secondary amino groups and without further tertiary amino groups. Examples thereof are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like, N-methylethylenediamine, N,N′-dimethylethylenediamine, N-ethyl-ethylenediamine, N,N′-diethylethylenediamine, N-propylethylenediamine, N,N′-dipropylethylenediamine, N-methylpropylenediamine, N,N′-dimethylpropylenediamine, N-ethylpropylenediamine, N,N′-diethylpropylenediamine, N-propylpropylenediamine, N,N′-dipropylpropylenediamine, N-methylbutylenediamine, N,N′-dimethylbutylenediamine, N-ethylbutylenediamine, N,N′-diethylbutylenediamine, additionally cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctane or 1,5-diaminocyclooctane, and also diaminodicyclohexylmethane, isophoronediamine, bis(aminomethyl)cyclohexane such as 1,1-bis(aminomethyl)cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like, and also phenylenediamine, such as o-, m- and p-phenylenediamine, tolylenediamine, such as o-, m- and p-tolylendiamine, xylylenediamine, naphthylenediamine, such as 1,2-, 1,3-, 1,4-, 1,5-, 1,8-, 2,3-, 2,6-, and 2,7-naphthylene, diaminodiphenyl sulfone, such as 2,2′-, 3,3′-, and 4,4′-diaminodiphenyl sulfone, and diaminobenzophenone, such as 2,2′-, 3,3′-, and 4,4′-diaminobenzophenone, and also diaminodiphenylmethane, such as 2,2′-, 3,3′-, and 4,4′-diaminodiphenyl, amine-terminated polyoxyalkylene polyols, for example Jeff-amines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

Particular preference is given to diamines having two primary amino groups and without further secondary/tertiary amino groups. Examples thereof are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like, and also cyclopentylenediamine, such as 1,2-diaminocyclopentane or 1,3-diaminocyclopentane, cyclohexylenediamine, such as 1,2-diaminocyclohexane, 1,3-diaminocyclohexane or 1,4-diaminocyclohexane, 1-methyl-2,4-diaminocyclohexane, 1-methyl-2,6-diaminocyclohexane, cycloheptylenediamine, such as 1,2-diaminocycloheptane, 1,3-diaminocycloheptane or 1,4-diaminocycloheptane, and cyclooctylenediamine, such as 1,2-diaminocyclooctane, 1,3-diaminocyclooctane, 1,4-diaminocyclooctane or 1,5-diaminocyclooctane, further diaminodicyclohexylmethane, isophoronediamine, bis(aminomethyl)cyclohexane, such as 1,1-bis(aminomethyl)-cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine and the like, and also phenylenediamine, such as o-, m- and p-phenylenediamine, tolylenediamine, such as o-, m- and p-tolylenediamine, xylylenediamine, naphthylenediamine, such as 1,2-, 1,3-, 1,4-, 1,5-, 1,8-, 2,3-, 2,6-, and 2,7-naphthylene, diaminodiphenyl sulfone, such as 2,2′-, 3,3′- and 4,4′-diaminodiphenyl sulfone, and diaminobenzophenone, such as 2,2′-, 3,3′- and 4,4′-diaminobenzophenone, and also diaminodiphenylmethane, such as 2,2′-, 3,3′- and 4,4′-diaminodiphenyl, amine-terminated polyoxyalkylene polyols, for example Jeff-amines, such as 4,9-dioxadodecane-1,12-diamine and 4,7,10-trioxamidecane-1,13-diamine, or else more regular amine-terminated polyoxyalkylene polyols, such as amine-terminated polyethylene glycols, amine-terminated polypropylene glycols or amine-terminated polybutylene glycols. The three last-mentioned amines (amine-terminated polyalkylene glycols) preferably have a molecular weight of 200 to 3000 g/mol.

More strongly preferred are diamines I.b having two primary amino groups and without further secondary/tertiary amino groups, in which A² is an aliphatic or aliphatic-alicyclic group. Examples of primary diamines I.b having aliphatic groups A² are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like. Preference among these is given to linear aliphatic groups, such as 1,2-ethylenediamine, 1,2- and 1,3-propylenediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine and eicosamethylenediamine, with particular preference being given to linear C₂-C₆-alkylene groups as group A², such as in 1,2-ethylenediamine, 1,3-propylenediamine, 1,4-butylenediamine, 1,5-pentylenediamine and hexamethylenediamine. Examples of primary diamines I.b with aliphatic-alicyclic groups A² are diaminodicyclohexylmethane, isophoronediamine, bis(aminomethyl)cyclohexane, such as 1,1-bis(aminomethyl)-cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like. Particular preference among these is given to isophoronediamine.

The molar ratio of the urea component (i-1) to the entirety of the amines (i-2d) and (i-2e) is preferably 20:1 to 1:20, more preferably 10:1 to 1:10, more preferably still 5:1 to 1:5, and more particularly 2:1 to 1:2.

If component (i-2e) is used in embodiment i-B, the molar ratio of component (i-2d) to (i-2e) is preferably 20:1 to 1 to 1:20, more preferably 10:1 to 1:10, more preferably still 5:1 to 1:5, and more particularly 2:1 to 1:2.

Highly branched polymers (i) and processes for preparing them are known in principle and are described for example in WO 2005/044897 and WO 2005/075541, hereby incorporated in full by reference.

The preparation is accomplished in general by reaction of components (i-1) and (i-2), and, optionally, further reactants, such as primary monoamines or melamine derivatives, at elevated temperature.

The reaction temperature is preferably 40 to 300° C., more preferably 100 to 250° C., and more particularly 150 to 230° C.

The reaction takes place frequently in the presence of a suitable catalyst. Suitable catalysts are bases, such as alkali metal and alkaline earth metal hydroxides, examples being sodium hydroxide, potassium hydroxide, calcium hydroxide or magnesium hydroxide, alkali metal and alkaline earth metal hydrogen carbonates, examples being sodium hydrogen carbonate, potassium hydrogen carbonate, calcium hydrogen carbonate or magnesium hydrogen carbonate, alkali metal and alkaline earth metal carbonates, examples being sodium carbonate, potassium carbonate, calcium carbonate or magnesium carbonate, basic, normucleophilic amines, such as DBU (diazabicycloundecene), DBN (diazabicyclononene), DABCO (diazabicyclooctane), nitrogen-containing heterocycles, such as imidazole, 1- and 2-methylimidazole, 1,2-dimethylimidazole, pyridine, lutidine, and the like. Suitable catalysts are additionally organic aluminum, tin, zinc, titanium, zirconium, and bismuth compounds, such as titanium tetrabutoxide, dibutyltin oxide, dibutyltin dilaurate, tin dioctoate, zirconium acetylacetonate, and mixtures thereof.

More particularly if the amine component (i-2) comprises melamine, however, it is preferred to use Brönsted acids or Lewis acids as catalysts. Suitable Brönsted acids are not only inorganic acids, such as, for example, mineral acids, examples being hydrofluoric acid, hydrochloric acid, hydrobromic acid, nitric acid, sulfuric acid, phosphoric acid, or amidosulfonic acid, but also ammonium salts, such as ammonium fluoride, ammonium chloride, ammonium bromide or ammonium sulfate, and also organic acids, such as methanesulfonic acid, acetic acid, trifluoroacetic acid, and p-toluenesulfonic acid. Suitable Brönsted acids are also the ammonium salts of organic amines, such as ethylamine, diethylamine, propylamine, dipropylamine, butylamine, dibutylamine, aniline, benzylamine or melamine, and also the ammonium salts of urea.

Suitable Lewis acids are all metal or semimetal halides in which the metal or semimetal possesses an electron pair vacancy. Examples thereof are BF₃, BCl₃, BBr₃, AlF₃, AlCl₃, AlBr₃, ethylaluminum dichloride, diethylaluminum chloride, TiF₄, TiCl₄, TiBr₄, VCl₅, FeF₃, FeCl₃, FeBr₃, ZnF2, ZnCl₂, ZnBr₂, Cu(I)F, Cu(I)Cl, Cu(I)Br, Cu(II)F₂, Cu(II)Cl₂, Cu(II)Br₂, Sb(III)F₃, Sb(V)F₅, Sb(III)Cl₃, Sb(V)Cl₅, Nb(V) Cl₅, Sn(II)F₂, Sn(II Cl₂, Sn(II)Br₂, Sn(IV)F₄, Sn(IV)Cl₄, and Sn(IV)Br₄.

Preferably, however, Brönsted acids are used. Preferred among these are the inorganic acids and more particularly the ammonium salts, such as ammonium chloride or ammonium bromide. Ammonium chloride is used especially.

The reaction can be carried out either at atmospheric pressure or at a superatmospheric pressure, such as, for example, at a pressure of 1 to 20 bar or 1 to 15 bar or 10 to 15 bar. In this case the pressure is frequently built up solely by the ammonia that is released in the course of the reaction, during the condensation of the components (i-1) and (i-2) (in the case of urea, thiourea, guanidine and/or biuret as component (i-1)); that is, the pressure increases as the reaction progresses, and can then be adjusted to the desired level. If the reaction is to be carried out at a superatmospheric pressure, however, the pressure can also be built up by way of an inert gas, such as by introduction of nitrogen, argon or carbon dioxide, preferably nitrogen, for example. This is appropriate more particularly when the reaction is to be carried out under a superatmospheric pressure right from the beginning, in other words before any notable pressure can be produced at all by the ammonia that is formed. The reaction pressure is determined more particularly by the nature of the amines used (component i-2). Hence the reaction can be carried out at atmospheric pressure if the at least one amine used has a boiling point which is above the reaction temperature. If, on the other hand, the boiling point is below the reaction temperature, then it is of course advantageous to carry out the reaction at superatmospheric pressure. However, even in the case of amines having a boiling point above the reaction temperature, it may under certain circumstances be advantageous to carry out the reaction under superatmospheric pressure, in order for example to achieve a greater reaction rate.

The reaction can be carried out if desired in a suitable solvent. Suitable solvents are inert: that is, under the prevailing reaction conditions, they do not react with the reactants, intermediates or products, and are not themselves degraded, by thermal decomposition, for example, under the prevailing reaction conditions either. Examples of suitable solvents are chlorinated aliphatic or aromatic hydrocarbons, such as methylene chloride, chloroform, dichloroethane, trichloroethane, chlorobenzene, chlorotoluene, and o-dichlorobenzene, open-chain and cyclic ethers, such as diethyl ether, dipropyl ether, tert-butyl methyl ether, tert-butyl ethyl ether, tetrahydrofuran, and 1,4-dioxane, polar aprotic solvents, such as N,N-dimethylformamide, N,N-dimethylacetamide, dimethyl sulfoxide, and acetonitrile, and polar protic solvents, examples being polyols, including polyether polyols, such as ethylene glycol, propylene glycol, diethylene glycol, triethylene glycol or polyethylene glycol. Preferred solvents are the abovementioned polyols, including polyether polyols. Preferably, though, the reaction is carried out in bulk, in other words without additional solvent. In this case frequently an amine (component i-2) serves as solvent, more particularly when it is liquid and is used in excess.

The reaction can be carried out by mixing all of the components and bringing the mixture to reaction by heating it to the desired reaction temperature. Alternatively it is possible for part of the components to be added first and the remaining constituents to be supplied gradually, the sequence of the addition being of minor importance. However, it has proven appropriate not to include less soluble components in the initial charge, such as melamine or urea, but instead to supply them gradually, continuously or in portions. The addition of the individual reactants advantageously takes place in such a way as to ensure their complete dissolution, so that their conversion in the condensation reaction is as complete as possible.

The reaction is generally carried out in reaction vessels that are typical for such condensation reactions, as for example in heatable stirred reactors, stirred pressure vessels or stirred autoclaves.

The reaction mixture is generally left to react until a desired maximum viscosity has been reached. The viscosity can be determined by sampling and determination by means of typical methods, such as with a viscometer, for example; in many cases, however, a sharp increase in viscosity is already evident visually in the course of the reaction, through the foaming of the reaction mixture, for example.

The reaction is preferably discontinued when the reaction mixture has a viscosity of not more than 100 000 mPas, e.g., from 250 to 100 000 mPas or from 500 to 100 000 mPas or from preferably 750 to 100 000 mPas (at 100° C.), more preferably of not more than 50 000 mPas, e.g., from 250 to 50 000 mPas or from 500 to 50 000 mPas or from preferably 750 to 50 000 mPas (at 100° C.), and more particularly of not more than 10 000 mPas, e.g., from 250 to 10 000 mPas or from 500 to 10 000 mPas or from preferably 750 to 10 000 mPas (at 100° C.).

If the viscosity of the reaction mixture is not to rise further, the reaction is discontinued. The reaction is preferably discontinued by lowering the temperature, preferably by lowering the temperature to <100°, e.g., 20 to <100°, preferably to <50° C., e.g., to 20 to <50° C.

In certain circumstances it may be necessary or desirable to work up and purify the reaction mixture obtained. Workup/purification may take place by means of typical methods, as for example by deactivating or removing the catalyst and/or by removing solvent and unreacted reactants. In general, however, the purity of the polycondensates obtained is sufficient, so there is no need for any further workup or purification and the product can be supplied directly to its further target use as a curative.

The products (i) are highly branched and substantially noncrosslinked.

### (ii) Highly Branched Polymer (ii)

If the polymer (ii) is obtainable by the condensation of an amine having at least three primary and/or secondary amino groups, it must be capable of self-condensation. Suitable therefor in principle are the above-described amines I.a, II and III, with the exception of melamine.

However, the highly branched polymer (ii) is preferably obtainable by condensation of at least two (different) amines having at least two primary and/or secondary amino groups, in which case at least one amine must comprise at least three primary and/or secondary amino groups.

If component (ii-1) comprises amines having two primary and/or secondary amino groups, then the molar ratio of said at least one amine having at least three primary and/or secondary amino groups to the amine/amines having two primary and/or secondary amino groups is preferably 100:1 to 1:100, more preferably 50:1 to 1:50, more preferably still 20:1 to 1:20, even more preferably 10:1 to 1:10, more particularly 2:1 to 1:10, and especially 1:1 to 1:5.

If only amines having at least three primary and/or secondary amino groups are used as component (ii-1), then it is preferred to use a mixture of at least two different amines having at least three primary and/or secondary amino groups.

In one preferred embodiment of the invention, in component (ii-1), said at least one amine having at least three primary and/or secondary amino groups comprises melamine. Besides melamine, however, component (ii-1) may also comprise further, non-melamine amines having at least three primary and/or secondary amino groups.

In one preferred embodiment the highly branched polymer (ii) is obtainable by condensation of
(ii-1a) at least one amine having at least three primary and/or secondary amino groups; and
(ii-1b) at least one amine having at least two primary and/or secondary amino groups.

The molar ratio of amine (ii-1a) to amine (ii-1b) is preferably 20:1 to 1:20, more preferably 10:1 to 1:10, more preferably still 5:1 to 1:5, even more preferably 1:1 to 1:5, and more particularly 1:1.5 to 1:5, especially 1:2 to 1:4.

In one particularly preferred embodiment (embodiment ii-C) the highly branched polymer (ii) is obtainable by condensation of

(ii-1aa) melamine;
(ii-1b) at least one amine having at least two primary and/or secondary amino groups; and
   (ii-2) optionally at least one amine having one primary amino group.

The molar ratio of melamine (ii-1aa) to the entirety of amines (ii-1 b) and (ii-2) is preferably 20:1 to 1:20, more preferably 10:1 to 1:10, more preferably still 5:1 to 1:5, even more preferably 1:1 to 1:5, and more particularly 1:1.5 to 1:5, especially 1:2 to 1:4.

As amine of component (ii-1 b) it is preferred to use an amine the formula I, I.a or II, with, of course, a non-melamine amine being used as amine II.

Among these amines preference is given, on account of the higher reactivity of primary amino groups, to those having at least two primary amine groups. Accordingly, in the preferred amines (ii-1b) of embodiment ii-C, in compounds I R^{a} and R^{b} are H, in compound I.a R^{a1} and R^{b1} are H, and in compounds II R^{d}, R^{e}, and R^{f} are H.

Particular preference among the compounds I, for use in embodiment ii-C of the invention, is given to those in which A is an aliphatic or aliphatic-alicyclic radical. Examples of primary diamines I having aliphatic groups A are 1,2-ethylenediamine, 1,2- and 1,3-propylenediamine, 2,2-dimethyl-1,3-propanediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine, eicosamethylenediamine, 2-butyl-2-ethyl-1,5-pentamethylenediamine, 2,2,4- or 2,4,4-trimethyl-1,6-hexamethylenediamine, 1,5-diamino-2-methylpentane, 1,4-diamino-4-methylpentane, and the like. Preference among these is given to linear aliphatic groups, such as 1,2-ethylenediamine, 1,2- and 1,3-propylenediamine, 1,4-butylenediamine, 1,5-pentylenediamine, hexamethylenediamine, heptamethylenediamine, octamethylenediamine, nonamethylenediamine, decamethylenediamine, undecamethylenediamine, dodecamethylenediamine, tridecamethylenediamine, tetradecamethylenediamine, pentadecamethylenediamine, hexadecamethylenediamine, heptadecamethylenediamine, octadecamethylenediamine, nonadecamethylenediamine and eicosamethylenediamine, with particular preference being given to linear C₂-C₆-alkylene groups as group A², such as in 1,2-ethylenediamine, 1,3-propylenediamine, 1,4-butylenediamine, 1,5-pentylenediamine and hexamethylenediamine. Examples of primary diamines I with aliphatic-alicyclic groups A are diaminodicyclohexylmethane, isophoronediamine, bis(aminomethyl)cyclohexane, such as 1,1-bis(aminomethyl)-cyclohexane, 1,2-bis(aminomethyl)cyclohexane, 1,3-bis(aminomethyl)cyclohexane or 1,4-bis(aminomethyl)cyclohexane, 2-aminopropylcyclohexylamine, 3(4)-aminomethyl-1-methylcyclohexylamine, and the like. Particular preference among these is given to isophoronediamine.

Preference is also given to amines I.a having two primary amino groups, such as diethylenetriamine, tetraethylenetriamine, pentaethylenetetramine, hexaethyleneheptamine, and the like.

Preference extends to amines II in which Y is N. With regard to suitable and preferred amines II in which Y is N, reference is made to the observations above.

As amine component (ii-1 b) it is preferred to use a diamine, more preferably a primary diamine. With regard to suitable and preferred (primary) diamines, reference is made to the elucidations relating to embodiment i-B.

Alternatively as amine component (ii-1b) it is preferred to use an amine having at least three primary and/or secondary amino groups, more preferably having at least three primary amino groups. Preferred amines having at least three primary and/or secondary amino groups are amines of the formulae I.a and II, with more preference being given to amines of the formula II. Preferred among these are amines in which Y is N. R^{d}, R^{e}, and R^{f} are preferably H. E¹, E², and E³ are independently of one another preferably C₂-C₆-alkylene. Concerning suitable and preferred amines having at least three primary and/or secondary amino groups, reference is made to the above elucidations relating to embodiment (i-B) and also to the general elucidations.

Also preferred is the use of a mixture of at least one diamine, preferably at least one primary diamine, with at least one amine having at least three primary and/or secondary amino groups, preferably having at least three primary amino groups.

With regard to suitable and preferred amines (ii-2) having a primary amino group, reference is made to the elucidations relating to embodiment (i-A) and (i-Aa). Preferably, however, no component (ii-2) is used.

In a more strongly preferred embodiment component (ii-1) comprises no melamine. In a more strongly preferred embodiment component (ii-1a) comprises no melamine.

In an alternatively particularly preferred embodiment (embodiment ii-D) the highly branched polymer (ii) is obtainable by condensation of (ii-1 ab) at least one amine having at least three primary and/or secondary amino groups which is different than melamine; and
(ii-1b) at least one amine having two primary and/or secondary amino groups.

The molar ratio of amine (ii-1 ab) to amine (ii-1 b) is preferably 20:1 to 1:20, more preferably 10:1 to 1:10, more preferably still 5:1 to 1:5, even more preferably 1:1 to 1:5, and more particularly 1:1.5 to 1:5, especially 1:2 to 1:4.

With regard to suitable and preferred amines (ii-lab) and (ii-1 b), reference is made to the elucidations relating to embodiment i-B.

Highly branched polymers (ii) and processes for preparing them are known in principle and are described for example in WO 2008/148766, hereby fully incorporated by reference.

The preparation takes place in general by reaction of all of components (ii-1) and, optionally, (ii-2) in analogy to the manner described for polymer (i), in this case using as catalyst—in particular when component (ii-1) comprises melamine—preferably a Brönsted acid or Lewis acid. Suitable and preferred Lewis acids have likewise been described for polymer (i).

(iii) Highly Branched Polymer (iii)

Highly branched polymers (iii) are prepared using components (iii-1) and (iii-2) in a molar ratio of preferably 20:1 to 1:20, more preferably 10:1 to 1:10, more preferably still 5:1 to 1:5, even more preferably 3:1 to 1:3, and more particularly 2.5:1 to 1:2.5.

If component (iii-1) comprises diisocyanates and polyisocyanates having at least three isocyanate groups, the molar ratio of said at least one diisocyanate to said at least one polyisocyanate is preferably 50:1 to 1:50, more preferably 20:1 to 1:20, and more particularly 10:1 to 1:10.

If component (iii-2) comprises amines having two and also amines having at least three primary and/or secondary amino groups, then the molar ratio of said at least one amine having at least three primary and/or secondary amino groups to said at least one amine having two primary and/or secondary amino groups is preferably 100:1 to 1:20, more preferably 50:1 to 1:10, and more particularly 25:1 to 1:10.

As component (iii-1) it is preferred to use at least one diisocyanate. Accordingly, component (iii-2) must comprise at least one amine having at least three primary and/or secondary amino groups.

Highly branched polymers (iii) and processes for preparing them are known in principle and are described for example in WO 03/066702, hereby fully incorporated by reference.

The preparation takes place in general by reaction of components (iii-1) and (iii-2) in analogy to the manner described for polymer (i).

If no masked/blocked isocyanate is used as isocyanate component (iii-1), the condensation reaction must be admixed with a terminating reagent for its discontinuation.

The focal groups, i.e., terminal groups, of the deficit functionality (NCO group) may be stopped, after the desired conversion and hence molecular weight have been attained, in one case by addition of an isocyanate-reactive, monofunctional compound, as for example by addition of a monoamine, amino alcohol or else alcohol. In this case preference is given to terminating reagents containing an amino group, since such reagents terminate ongoing reaction more quickly than, for example, alcohols, with the consequence that the resulting products are more well-defined.

Examples of suitable monoamines are methylamine, ethylamine, propylamine, isopropylamine, n-butylamine, sec-butylamine, isobutylamine, tert-butylamine, pentylamine, hexylamine, ethanolamine, propanolamine, isopropanolamine, pentanolamine, (2-methoxyethyl)amine, (2-ethoxyethyl)amine, (3-methoxypropyl)amine, (3-ethoxypropyl)amine, [3-(2-ethylhexyl)propyl]amine, 2-(2-aminoethoxy)ethanol, cyclohexylamine, aminomethylcyclohexane, aniline, benzylamine, and the like.

Also possible, furthermore, is the addition of a terminating compound containing two or more isocyanate-reactive groups. In this case, in accordance with a convergent synthesis route, two or more polymer arms are added to the difunctional or polyfunctional termination compound, which leads to a sudden increase in the average molar weight of the polymer, well above the average molar weight of the polymer at the time the stopper was added.

Examples of suitable difunctional or polyfunctional amines are primary amines having one or more secondary and/or tertiary amino functions, as already described above for the synthesis of the polymers of type (i), or the like.

As terminating reagent it is preferred to use primary monoamines, i.e., amines having a single primary amino group and without further secondary or tertiary amino functions.

### (iv) Highly Branched Polymer (iv)

Highly branched polymers (iv) are prepared using components (iv-1) and (iv-2) in a molar ratio of preferably 20:1 to 1:20, more preferably 10:1 to 1:10, more preferably still 5:1 to 1:5, even more preferably 3:1 to 1:2, more particularly 2.5:1 to 1:1.5, and especially 2:1 to 1:1.

If component (iv-1) comprises dicarboxylic acids and/or derivatives thereof and polycarboxylic acids having at least three carboxyl groups and/or derivatives thereof, then the molar ratio of said at least one dicarboxylic acid/said at least one dicarboxylic acid derivative to said at least one polycarboxylic acid/said at least one carboxylic acid derivative is preferably 50:1 to 1:50, more preferably 20:1 to 1:20, and more particularly 10:1 to 1:10.

If component (iv-2) comprises amines having two primary and/or secondary amino groups, then the molar ratio of said at least one amine having at least three primary and/or secondary amino groups to the amine/amines having two primary and/or secondary amino groups is preferably 100:1 to 1:20, more preferably 50:1 to 1:10, and more particularly 25:1 to 1:10.

As already observed, it is preferred as component (iv-1) to use a dicarboxylic acid, a dicarboxylic acid derivative or a mixture thereof. In this case, accordingly, it is necessary as component (iv-2) to use at least one amine having at least three primary and/or secondary amino groups.

With regard to suitable and preferred amines having at least three primary and/or secondary amino groups, reference is made to the general elucidations concerning such amines. More particularly the amine is selected from those of the formula I.a and II.

Highly branched polymers (iv) and processes for preparing them are known in principle and are described for example in WO 2009/021986, hereby fully incorporated by reference.

### (v) Oligomer (v)

Among the urea derivatives referred to above, preference for the preparation of the oligomer (v) is given to the substituted ureas, thiourea, the substituted thioureas, guanidine, the substituted guanidines, and the carbonic esters. More strongly preferred are the substituted ureas, thiourea, guanidine, and the carbonic esters. Preference among these is given to thiourea, N,N′-dimethylurea, N,N′-diethylurea, N,N′-di-n-butylurea, N,N′-diisobutylurea, N,N,N′,N′-tetramethylurea, guanidine, in the form particularly of guanidine carbonate, dimethyl carbonate, diethyl carbonate, ethylene carbonate, and 1,2-propylene carbonate. Even more strongly preferred are the substituted ureas, thiourea, and the carbonic esters. Preference among these is given to thiourea, N,N′-dimethylurea, N,N′-diethylurea, N,N′-di-n-butylurea, N,N′-diisobutylurea, N,N,N′,N′-tetramethylurea, dimethyl carbonate, diethyl carbonate, ethylene carbonate, and 1,2-propylene carbonate.

Use is made more particularly as component (v-1) of urea or a substituted urea of the formula R¹R²N—C(═O)—NR³R⁴ in which R¹, R², R³, and R⁴ independently of one another are as defined above. Preferably R¹ and R³ are H or C₁-C₄-alkyl, especially methyl or ethyl, and R² and R⁴ are C₁-C₄-alkyl, especially methyl or ethyl. Particular preference is given to using as component (v-1) urea itself, optionally in combination with one of the aforementioned urea derivatives, and more particularly just urea.

Concerning suitable and preferred amines having at least two or having at least three primary and/or secondary amino groups, reference is made to the observations above.

Particular preference is given to using amines having at least three primary and/or secondary, preferably primary, amino groups. More particularly compounds II are used. Use is made especially of compounds II in which Y is N.

The oligomeric compound (v) is preferably the condensation product of one molecule of urea or urea derivative with one or two molecules of amine having two or preferably having three primary and/or secondary amino groups, more preferably having three primary amino groups.

Oligomers (v) can be prepared in accordance with typical condensation processes. An onward reaction to polymeric products can be prevented, for example, by using the amine (v-ii) in a large excess (for example, urea(derivative) (v-1): amine (v-2)=at least 1:10 or preferably at least 1:30 or more preferably at least 1:100) and/or monitoring and limiting the conversion of the condensation reaction, by carrying out the reaction at moderate temperatures and/or suddenly lowering the temperature following reaction at relatively high reaction temperatures, and so substantially slowing the reaction rate, and/or destroying or neutralizing any catalysts added, after the desired degree of conversion has been reached, and/or carrying out the condensation reaction under conditions of high dilution in a suitable solvent.

On the other hand, oligomers (v) are also formed as by-products in the preparation of the polymers (i) and may be isolated from their reaction mixture, by extraction for example with a solvent in which the polymer (i) is insoluble.

### (vi) Oligomer (vi)

Concerning suitable and preferred amines having at least two primary and/or secondary amino groups, reference is made to the observations above. It is preferred to use amines of the formula I. Preferred among these are amines in which A is an alkylene radical. With particular preference, A is C₂-C₁₀-alkylene, more preferably linear C₂-C₁₀-alkylene, and more particularly linear C₂-C₆-alkylene, such as 1,2-ethylene, 1,3-propylene, 1,4-butylene, 1,5-pentylene and hexamethylene. In these amines preferably R^{a} and R^{b} are H.

The oligomeric compound (vi) is preferably the condensation product of one molecule of melamine with one, two or three molecules of amine.

Oligomers (vi) can be prepared in accordance with typical condensation processes. An onward reaction to polymeric products can be prevented, for example, by using the amine (v-ii) in a large excess (for example, melamine (vi-1): amine (vi-2)=at least 1:30 or preferably at least 1:100) and/or monitoring and limiting the conversion of the condensation reaction, by carrying out the reaction at moderate temperatures and/or suddenly lowering the temperature following reaction at relatively high reaction temperatures, and so substantially slowing the reaction rate, and/or destroying or neutralizing any catalysts added, after the desired degree of conversion has been reached, and/or carrying out the condensation reaction under conditions of high dilution in a suitable solvent.

On the other hand, oligomers (vi) are also formed as by-products in the preparation of the polymers (ii) and may be isolated from their reaction mixture, by extraction for example with a solvent in which the polymer (ii) is insoluble.

The compounds (I) to (vi) are used in accordance with the invention as curatives for epoxy resins.

### Epoxy Resins

With regard to the epoxy resins for curing there is no restriction whatsoever on the inventive use.

The majority of commercial uncured epoxy resins are prepared by coupling epichlorohydrin onto compounds which possess at least two reactive hydrogen atoms, such as polyphenols, monoamines and diamines, aminophenols, heterocyclic imides and amides, aliphatic diols or polyols or dimeric fatty acids. Epoxy resins derived from epichlorohydrin are referred to as glycidyl-based resins.

The majority of epoxy resins available commercially at the present time derive from the diglycidyl ether of bisphenol A (DGEBA resins) and possess the general formula

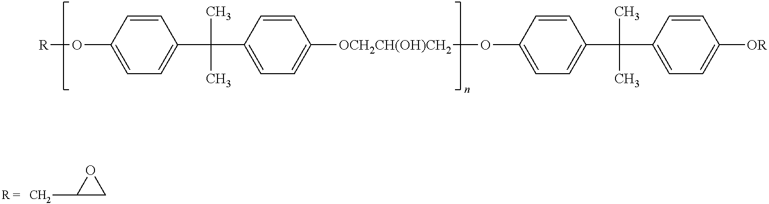

in which n stands for 0 to approximately 40.

Other important epoxy resins are phenol-based and cresol-based epoxy novolaks, examples being epoxy resins which derive from the diglycidyl ether of bisphenol F. Novolaks are prepared by the acid-catalyzed condensation of formaldehyde and phenol or cresol. The epoxidation of the novolaks leads to epoxy novolaks.

Other classes of glycidyl-based epoxy resins derive from glycidyl ethers of aliphatic diols, such as butane-1,4-diol, hexane-1,6-diol, pentaerythritol or hydrogenated bisphenol A; aromatic glycidylamines, an example being the triglycidyl adduct of p-aminophenol or the tetraglycidylamine of methylenedianilide; heterocyclic glycidylimides and amides, e.g., triglycidyl isocyanurate; and glycidyl esters, such as the diglycidyl ester of dimeric linoleic acid, for example.

The epoxy resins may also derive from other epoxides (non-glycidyl ether epoxy resins). Examples are the diepoxides of cycloaliphatic dienes, such as 3,4-epoxycyclohexylmethyl 3,4-epoxycyclohexanecarboxylate and 4-epoxyethyl-1,2-epoxycyclohexane.

The condensation products used in accordance with the invention are particularly suitable for the curing of epoxy resins based on glycidyl polyethers of bisphenol A, bisphenol F, and novolak resins.

Curatives used in accordance with the invention are one or more of the condensation products (i) to (vi). They can be used as sole curatives; it is, however, also possible to use them in combination with one or more conventional curatives for epoxy resins.

The conventional curatives include aliphatic and aromatic polyamines, polyamidoamines, urons, amides, guanidines, aminoplasts and phenoplasts, polycarboxylic polyesters, dihydroxy and polyhydroxy compounds, thiols, imidazoles, imidazolines, and certain isocyanates, and also latent polyfunctional curatives.

Polyamine curatives crosslink epoxy resins through reaction of primary or secondary amino functions of polyamines with terminal epoxide groups of the epoxy resins. Suitable polyamines are, for example, aliphatic polyamines such as ethylenediamine, 1,2- and 1,3-propylenediamine, neopentanediamine, hexamethylenediamine, octamethylenediamine, 1,10-diaminodecane, 1,12-diaminododecane, diethylene-triamine, triethylenetetramine, tetraethylenepentamine, and the like; cycloaliphatic diamines, such as 1,2-diaminocyclohexane, 1,3-bis(aminomethyl)cyclohexane, 1-methyl-2,4-diaminocyclohexane, 4-(2-aminopropan-2-yl)-1-methylcyclohexan-1-amine, isophoronediamine, 4,4′-diaminodicyclohexylmethane, 3,3′-dimethyl-4,4′-diaminodicyclohexylmethane, norbornanediamine, menthanediamine, menthene-diamine and the like; aromatic diamines, such as tolylenediamine, xylylenediamine, more particularly meta-xylylenediamine, bis(4-aminophenyl)methane (MDA or methylenedianiline), bis(4-aminophenyl)sulfone (also known as DADS, DDS or dapsone), and the like; cyclic polyamines, such as piperazine, N-aminoethylpiperazine and the like; polyetherdiamines, examples being the reaction product of polypropylene oxide or polyethylene oxide or butylene oxide or pentylene oxide or poly(1,4-butanediol) or polytetrahydrofuran or mixtures of the 5 last-mentioned alkylene oxides with propylene oxide with ammonia, e.g., 4,7,10-trioxamidecane-1,3-diamine, 4,7,10-trioxamidecane-1,13-diamine, XTJ-500, XTJ-501, XTJ-511, XTJ-542, XTJ-559, XTJ-566, XTJ-568 (Huntsman), 1,8-diamino-3,6-dioxaoctane (XTJ-504 from Huntsman), 1,10-diamino-4,7-dioxadecane (XTJ-590 from Huntsman), 1,12-diamino-4,9-dioxadodecane (BASF), 1,3-diamino-4,7,10-trioxamidecane (BASF), polyetheramine T 5000, Jeffamines and the like; and polyamide diamines (amidopolyamines), which are obtainable through the reaction of dimeric fatty acids (e.g., dimeric linoleic acid) with low molecular mass polyamines, such as diethylenetriamine or triethylenetetramine.

A further class of suitable curatives are those known as urons (urea derivatives), such as 3-(4-chlorophenyl)-1,1-dimethylurea (monuron), 3-(3,4-dichlorophenyl)-1,1-dimethylurea (diuron), 3-phenyl-1,1-dimethylurea (fenuron), 3-(3-chloro-4-methylphenyl)-1,1-dimethylurea (chlortoluron), and the like.

Suitable curatives are also carbamides, such as tolyl-2,4-bis(N,N-dimethylcarbamide), and tetraalkylguanidines, such as N,N,N′N′-tetramethylguanidine.

Melamine-, urea-, and phenol-formaldehyde adducts, which are also referred to as aminoplasts or phenoplasts, respectively, form a further class of epoxide curatives.

Polycarboxylic polyesters as curatives are being employed increasingly in powder coatings. The crosslinking takes place by virtue of the reaction of the free carboxyl groups with the epoxide groups of the epoxy resin.

Further polyfunctional curatives comprise aromatic compounds having two or more hydroxyl groups. Examples of such are resins obtainable by the reaction of phenol or alkylated phenols, such as cresol, with formaldehyde, examples being phenol novolaks, cresol novolaks and dicyclopentadiene novolaks; furthermore, resins of nitrogen-containing heteroaromatics, such as benzoguanamine-phenol-formaldehyde resins or benzoguanamine-cresol-formaldehyde resins, acetoguanamine-phenol-formaldehyde resins or acetoguanamine-cresol-formaldehyde resins, and melamine-phenol-formaldehyde resins or melamine-cresol-formaldehyde resins, and also hydroxylated arenes, such as hydroquinone, resorcinol, 1,3,5-trihydroxybenzene, 1,2,3-trihydroxybenzene (pyrogallol), 1,2,4-trihydroxybenzene (hydroxyhydroquinone), 3,4,5-trihydroxybenzoic acid (gallic acid) or derivatives thereof, 1,8,9-trihydroxyanthracene, (dithranol or 1,8,9-anthracenetriol), 1,2,10-trihydroxyanthracene (anthrarobin) and 2,4,5-trihydroxypyrimidine; additionally, alkanes substituted by hydroxylated arenes, such as triphenolmethane, triphenolethane and tetraphenolethane. Further examples are phosphinates and phosphonates derived from hydroquinone and naphthoquinone, as described in WO 2006/034445, hereby fully incorporated by reference.

Further polyfunctional curatives comprise thiols, imidazoles, such as imidazole, 1-methylimidazole, 2-methylimidazole, 2-ethyl-4-methylimidazole, 1-cyanoethyl-imidazole and 2-phenylimidazole, and imidazolines, such as 2-phenylimidazoline.

Blocked isocyanates have more recently been used as latent curatives for water-based coatings.

Dicyandiamide (dicy), HN═C(NH₂)(NHCN), is a latent polyfunctional curative frequently employed in powder coatings and electrical laminates.

Also suitable are reaction products of dicy with amines, known as bisguanidines, such as HAT 2844 from Vantico.

Further suitable latent polyfunctional curatives are boron trifluoride-amine adducts such as BF₃-monoethylamine, and quaternary phosphonium compounds.

Preferred conventional curatives are selected from the abovementioned aliphatic polyamines, cycloaliphatic diamines, polyetheramines, and mixtures thereof.

If one or more conventional curatives are used alongside the curatives (i) to (vi) employed in accordance with the invention, the weight ratio of the total amount of all the curatives (i) to (vi) used to the total amount of all the conventional curatives used is preferably from 1:1000 to 100:1, more preferably from 1:100 to 50:1, and more particularly 1:50 to 30:1.

The curatives (i.e., the entirety of all curatives used in accordance with the invention and any conventional curatives used) are employed in amounts such that the ratio of the number of all the reactive groups (in the case of the curatives used in accordance with the invention, these are all the hydrogen atoms on primary and secondary amino functions) to the number of all the epoxide groups in the epoxy resin is 2:1 to 1:2, preferably 1.5:1 to 1:1.5, and more particularly about 1:1. At a stoichiometric ratio of approximately 1:1, a cured resin having optimum thermoset properties is obtained. Depending on the desired properties of the resin after crosslinking, however, it may also be sensible to use curative and epoxy resin in different proportions of the reactive groups.

The number of epoxide groups in the epoxy resin is cited as what is called the epoxide equivalent. The epoxide equivalent is determined in accordance with DIN 16 945.

The number of reactive groups in the curative is calculated, in the case of amine curatives, which encompass the condensation products used in accordance with the invention, via the amine number in accordance with DIN 16945.

The curing of the epoxy resins is accomplished, preferably, thermally by heating of the mixture of epoxy resin and curative to a temperature of preferably 5 to 150° C., more preferably 20 to 150° C., even more preferably from 25 to 125° C., and more particularly 30 to 100° C. In the lower temperature range (5 to about 25° C.), which indeed corresponds to the ambient temperature that is normally prevailing, it is, of course, sufficient to mix epoxy resin and curative. Which temperature is suitable depends on the particular curatives and epoxy resins and on the desired cure rate, and can be determined in each individual case by the skilled worker on the basis, for example, of simple preliminary tests.

Alternatively the curing takes place with, preferably, microwave induction.

The invention further provides a composition comprising

(a) at least one condensation product (i) to (vi) as defined above;
(b) at least one epoxy resin which is in uncured or part-cured form; and
(c) optionally at least one conventional epoxy resin curative.

With regard to suitable and preferred condensation products (i) to (vi), epoxy resins, conventional curatives, and the ratios between epoxy resin and curative and also between inventive and conventional curatives, reference is made to the observations above.

Under certain circumstances, depending on curative and epoxy resin, the composition is of unaltered stability over a relatively long time only at low temperatures, as for example below 25° C. or below 20° C. or below 10° C. or below 5° C. or below 0° C., and so in many cases it is necessary to store it at low temperatures.

Besides components (a), (b), and (c), the composition of the invention may further comprise additional conventional additives. It is self-evident that these additives generally remain in the cured resin, unless they are volatile and do not react with the epoxy resin, the curative(s) or other additives and undergo complete or partial volatilization during the thermal curing process.

Suitable conventional additives comprise, for example, antioxidants, UV absorbers/light stabilizers, metal deactivators, antistats, reinforcing materials, fillers, antifogging agents, blowing agents, biocides, plasticizers, lubricants, emulsifiers, colorants, pigments, rheological agents, impact tougheners, catalysts, adhesion regulators, optical brighteners, flame retardants, antidropping agents, nucleating agents, solvents, and reactive diluents ands also mixtures thereof.

The light stabilizers/UV absorbers, antioxidants, and metal deactivators that are used optionally preferably have a high migration stability and temperature resistance. They are selected, for example, from groups a) to t). The compounds of groups a) to g) and i) constitute light stabilizers/UV absorbers, while compounds j) to t) act as stabilizers.

a) 4,4-diarylbutadienes,
b) cinnamic esters,
c) benzotriazoles,
d) hydroxybenzophenones,
e) diphenylcyanoacrylates,
f) oxamides,
g) 2-phenyl-1,3,5-triazines;
h) antioxidants,
i) nickel compounds,
j) sterically hindered amines,
k) metal deactivators,
I) phosphites and phosphonites,
m) hydroxylamines,
n) nitrones,
o) amine oxides,
p) benzofuranones and indolinones,
q) thiosynergists,
r) peroxide scavengers,
s) polyamide stabilizers, and
t) basic costabilizers.

Group a) of the 4,4-diarylbutadienes includes for example compounds of the formula A.

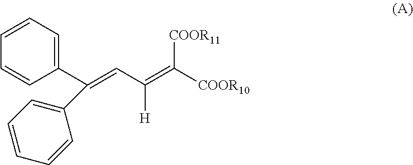

The compounds are known from EP-A-916 335. The substituents R₁₀ and/or R₁₁ are preferably C₁-C₈ alkyl and C₅-C₈ cycloalkyl.

Group b) of the cinnamic esters includes for example 2-isoamyl 4-methoxycinnamate, 2-ethylhexyl 4-methoxycinnamate, methyl α-methoxycarbonylcinnamate, methyl α-cyano-β-methyl-p-methoxycinnamate, butyl α-cyano-β-methyl-p-methoxycinnamate, and methyl α-methoxycarbonyl-p-methoxycinnamate.

Group c) of the benzotriazoles includes for example 2-(2′-hydroxyphenyl)-benzotriazoles such as 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-Z-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)-benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxy-carbonylethyl)phenylbenzotriazole, 2,2′-methylenebis[4-(1,1,3,3-tetramethylbutyl)-6-benzotriazol-2-ylphenol]; the product of esterifying 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃]₂ where R=3′-tert-butyl-4′-hydroxy-5′-2H-benzotriazol-2-ylphenyl, and mixtures thereof.

Group d) of the hydroxybenzophenones includes for example 2-hydroxybenzophenones such as 2-hydroxy-4-methoxybenzophenone, 2,2′-dihydroxy-4-methoxybenzophenone, 2,4-dihydroxybenzophenone, 2,2′,4,4′-tetra-hydroxybenzophenone, 2,2′-dihydroxy-4,4′-dimethoxybenzophenone, 2,2′-dihydroxy-4,4′-dimethoxybenzophenone, 2-hydroxy-4-(2-ethylhexyloxy)benzophenone, 2-hydroxy-4-(n-octyloxy)benzophenone, 2-hydroxy-4-methoxy-4′-methylbenzophenone, 2-hydroxy-3-carboxybenzophenone, 2-hydroxy-4-methoxybenzophenone-5-sulfonic acid and its sodium salt, and 2,2′-dihydroxy-4,4′-dimethoxybenzophenone-5,5′-bissulfonic acid and its sodium salt.

Group e) of the diphenylcyanoacrylates includes for example ethyl 2-cyano-3,3-diphenylacrylate, obtainable commercially for example under the name Uvinul® 3035 from BASF AG, Ludwigshafen, 2-ethylhexyl 2-cyano-3,3-diphenylacrylate, obtainable commercially for example as Uvinul® 3039 from BASF AG, Ludwigshafen, and 1,3-bis[(2′-cyano-3′,3′-diphenylacryloyl)oxy]-2,2-bis{[2′-cyano-3′,3′-diphenyl-acryloyl)oxy]methyl}propane, obtainable commercially for example under the name Uvinul® 3030 from BASF AG, Ludwigshafen.

Group f) of the oxamides includes for example 4, 4′-dioctyloxyoxanilide, 2,2′-di-ethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, and also mixtures of ortho-, para-methoxy-disubstituted oxanilides and mixtures of ortho- and para-ethoxy-disubstituted oxanilides.

Group g) of the 2-phenyl-1,3,5-triazines includes for example 2-(2-hydroxyphenyl)-1,3,5-triazines such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethylphenyl)-1,3,5-triazine, 2-[2-hydroxy-4-(2-hydroxy-3-octyloxypropoxy)phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, and 2-(2-hydroxyphenyl)-4-(4-methoxyphenyl)-6-phenyl-1,3,5-triazine.

Group h) of the antioxidants includes, for example:
h.1) Alkylated monophenols such as, for example, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, unbranched or sidechain-branched nonylphenols such as, for example, 2,6-dinonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol, and mixtures thereof.
h.2) Alkylthiomethylphenols such as, for example, 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol.
h.3) Hydroquinones and alkylated hydroquinones such as, for example, 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, and bis-(3,5-di-tert-butyl-4-hydroxyphenyl)adipate.
h.4) Tocopherols, such as, for example, α-tocopherol, β-tocopherol, γ-tocopherol, δ-tocopherol, and mixtures thereof (vitamin E).
h.5) Hydroxylated thiodiphenyl ethers such as, for example, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), and 4,4′-bis(2,6-dimethyl-4-hydroxyphenyl) disulfide.
h.6) Alkylidenebisphenols such as, for example, 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′-tert-butyl-2-hydroxy-5-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)pentane.
h.7) Benzyl compounds such as, for example, 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, 1,3,5-tri(3,5-di-tert-butyl-4-hydroxybenzyl)-2,4,6-trimethylbenzene, di(3,5-di-tert-butyl-4-hydroxybenzyl)sulfide, isooctyl 3,5-di-tert-butyl-4-hydroxybenzylmercaptoacetate, bis(4-tert-butyl-3-hydroxy-2,6-dimethylbenzyl)dithiol terephthalate, 1,3,5-tris(3,5-di-tert-butyl-4-hydroxybenzyl) isocyanurate, 1,3,5-tris(4-tert-butyl-3-hydroxy-2,6-dimethylbenzyl)isocyanurate, 3,5-di-tert-butyl-4-hydroxybenzyl-phosphoric acid dioctadecyl ester, and 3,5-di-tert-butyl-4-hydroxybenzyl-phosphoric acid monoethyl ester, calcium salt.
h.8) Hydroxybenzylated malonates such as, for example, dioctadecyl 2,2-bis(3,5-di-tert butyl-2-hydroxybenzyl)malonate, dioctadecyl-2-(3-tert-butyl-4-hydroxy-5-methylbenzyl)malonate, didodecyl mercaptoethyl-2,2-bis(3,5-di-tert-butyl-4-hydroxybenzyl)malonate, and bis[4-(1,1,3,3-tetramethylbutyl)phenyl]2,2-bis(3,5-di-tert-butyl-4-hydroxybenzyl)malonate.
h.9) Hydroxybenzyl aromatics such as, for example, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, and 2,4,6-tris(3,5-di-tert-butyl-4-hydroxybenzyl)phenol.
h.10) Triazine compounds such as, for example, 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, and 1,3,5-tris(3,5-dicyclohexyl-4-hydroxybenzyl)isocyanurate.
h.11) Benzylphosphonates such as, for example, dimethyl 2,5-di-tert-butyl-4-hydroxybenzylphosphonate, diethyl 3,5-di-tert-butyl-4-hydroxybenzylphosphonate (diethyl (3,5-bis(1,1-dimethylethyl)-4-hydroxyphenyl)methylphosphonate), dioctadecyl 3,5-di-tert-butyl-4-hydroxybenzylphosphonate, dioctadecyl 5-tert-butyl-4-hydroxy-3-methylbenzylphosphonate, and the calcium salt of monoethyl 3,5-di-tert-butyl-4-hydroxybenzylphosphonate.
h.12) Acylaminophenols such as, for example, 4-hydroxylauranilide, 4-hydroxystearanilide, 2,4-bisoctylmercapto-6-(3,5-tert-butyl-4-hydroxyanilino)-s-triazine, and octyl N-(3,5-di-tert-butyl-4-hydroxyphenyl)carbamate.
h.13) Esters of β-(3,5-di-tert-butyl-4-hydroxyphenyl)propionic acid with monohydric or polyhydric alcohols such as, for example, with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.14) Esters of β-(5-tert-butyl-4-hydroxy-3-methylphenyl)propionic acid with monohydric or polyhydric alcohols such as, for example, with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.15) Esters of β-(3,5-dicyclohexyl-4-hydroxyphenyl)propionic acid with monohydric or polyhydric alcohols such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.16) Esters of 3,5-di-tert-butyl-4-hydroxyphenylacetic acid with monohydric or polyhydric alcohols such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.

h.17) Amides of β-(3,5-di-tert-butyl-4-hydroxyphenyl)propionic acid such as, for example, N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (e.g., Naugard®XL-1 from Uniroyal).
h.18) Ascorbic acid (vitamin C)
h.19) Aminic antioxidants, such as, for example, N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, for example, p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)-phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl) sebacate, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidineethanol [CAS number 65447-77-0], (for example, Tinuvin® 622 from Ciba Specialty Chemicals, Inc.), polymer of 2,2,4,4-tetramethyl-7-oxa-3,20-diazadispiro[5.1.11.2]heneicosan-21-one and epichlorohydrin [CAS No.: 202483-55-4], (for example Hostavin® N30 from Clariant, Germany.).

Group i) of the nickel compounds includes for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyl dithiocarbamate, nickel salts of 4-hydroxy-3,5-di-tert-butylbenzylphosphonic acid monoalkyl esters such as of the methyl or ethyl esters, for example, nickel complexes of ketoximes such as, for example, of 2-hydroxy-4-methylphenyl undecyl ketoxime, and the nickel complex of 1-phenyl-4-lauroyl-5-hydroxypyrazole, with or without additional ligands.

Group j) of the sterically hindered amines includes for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate (n-butyl-3,5-di-tert-butyl-4-hydroxybenzylmalonic acid bis(1,2,2,6,6-pentamethylpiperidyl)ester), condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl) 1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensation products of N,N′-bis(2,2,6,6-tetramethyl-4-piperidyl)hexamethylenediamine and 4-morpholino-2,6-dichloro-1,3,5-triazine, condensation product of N,N′-bis(2,2,6,6-tetramethyl-4-piperidyl)hexamethylenediamine and formic esters (CAS No. 124172-53-8, e.g., Uvinul® 4050H from BASF AG, Ludwigshafen), condensation product of 2-chloro-4,6-bis(4-n-butylamino-2,2,6,6-tetramethylpiperidyl)-1,3,5-triazine and 1,2-bis(3-aminopropylamino)ethane, condensation product of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylenediamine and 4-cyclohexylamino-2,6-dichloro-1,3,5-triazine, condensation product of 1,2-bis(3-aminopropylamino)ethane and 2,4,6-trichloro-1,3,5-triazine and also 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro[4.5]decane, reaction product of 7,7,9,9-tetramethyl-2-cycloundecyl-1-oxa-3,8-diaza-4-oxospiro[4.5]decane and epichlorohydrin, 1,1-bis(1,2,2,6,6-pentamethyl-4-piperidyloxycarbonyl)-2-(4-methoxyphenyl)ethene, N,N′-bisformyl-N,N′-bis(2,2,6,6-tetramethyl-4-piperidyl)hexamethylenediamine, diester of 4-methoxymethylenemalonic acid with 1,2,2,6,6-pentamethyl-4-hydroxypiperidine, poly[methylpropyl-3-oxo-4-(2,2,6,6-tetramethyl-4-piperidyl)]siloxane, reaction product of maleic anhydride-α-olefin copolymer and 2,2,6,6-tetramethyl-4-aminopiperidine or 1,2,2,6,6-pentamethyl-4-aminopiperidine, copolymers of (partially) N-piperidin-4-yl-substituted maleimide and a mixture of α-olefins such as, for example, Uvinul® 5050H (BASF AG), 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine and a carbon radical of t-amyl alcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate, 2,4-bis{N[1-(2-hydroxy-2-methylpropoxy)-2,2,6,6-tetramethylpiperidin-4-yl]-N-butylamino}-6-(2-hydroxyethylamino)-s-triazine, N,N′-bisformyl-N,N′-bis(1,2,2,6,6-pentamethyl-4-piperidyl)hexamethylenediamine, hexahydro-2,6-bis(2,2,6,6-tetramethyl-4-piperidyl)-1H,4H,5H,8H-2,3a,4a,6,7a,8a-hexaazacyclopenta[def]fluorene-4,8-dione (e.g. Uvinul® 4049 from BASF AG, Ludwigshafen), poly[[6-(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]) [CAS No. 71878-19-8], 1,3,5-triazine-2,4,6-triamine, N,N″′-[1,2-ethanediylbis[[4,6-bis[butyl(1,2,2,6,6-pentamethyl-4-piperidinyl)amino]-1,3,5-triazin-2-yl]imino]-3,1-propanediyl]]bis[N′,N″-dibutyl-N′,N″-bis(1,2,2,6,6-pentamethyl-4-piperidinyl) (CAS No. 106990-43-6) (e.g., Chimassorb 119 from Ciba Specialty Chemicals, Inc.).

Group k) of the metal deactivators includes for example N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoylbisphenyl hydrazide, N,N′-diacetyladipic dihydrazide, N,N′-bis(salicyloyl)oxalic dihydrazide, and N,N′-bis(salicyloyl)thiopropionyl dihydrazide.

Group I) of the phosphites and phosphonites includes for example triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyloxy pentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-dibenzo[d,f][1,3,2]dioxaphosphepine, 6-fluoro-2,4,8,10-tetra-tert-butyl-[2-methyl-dibenzo[d,g][1,3,2]dioxaphosphocine, bis(2,4-di-tert-butyl-6-methylphenyl)methyl phosphite, bis(2,4-di-tert-butyl-6-methylphenyl)ethyl phosphite, 2,2′,2″-nitrilo[triethyl tris(3,3′,5,5′-tetra-tert-butyl-1,1′-biphenyl-2,2′-diyl)phosphite], and 2-ethylhexyl 3,3′,5,5′-tetra-tert-butyl-1,1′-biphenyl-2,2′-diyl phosphite.

Group m) of the hydroxylamines includes for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecyl-hydroxylamine, N-hexadecyl-N-octadecylhydroxylamine, N-heptadecyl-N-octa-decylhydroxylamine, N-methyl-N-octadecylhydroxylamine, and N,N-dialkylhydroxylamine from hydrogenated tallow fatty amines.

Group n) of the nitrones includes for example N-benzyl α-phenyl nitrone, N-ethyl α-methyl nitrone, N-octyl α-heptyl nitrone, N-lauryl α-undecyl nitrone, N-tetradecyl α-tridecyl nitrone, N-hexadecyl α-pentadecyl nitrone, N-octadecyl α-heptadecyl nitrone, N-hexadecyl α-heptadecyl nitrone, N-octadecyl α-pentadecyl nitrone, N-heptadecyl α-heptadecyl nitrone, N-octadecyl α-hexadecyl nitrone, N-methyl α-heptadecyl nitrone, and nitrones derived from N,N-dialkylhydroxylamines prepared from hydrogenated tallow fatty amines.

Group o) of the amine oxides includes for example amine oxide derivatives as described in U.S. Pat. Nos. 5,844,029 and 5,880,191, didecylmethylamine oxide, tridecylamine oxide, tridodecylamine oxide and trihexadecylamine oxide.

Group p) of the benzofuranones and indolinones includes for example those described in U.S. Pat. Nos. 4,325,863; 4,338,244; 5,175,312; 5,216,052; 5,252,643; in DE-A-4316611; in DE-A-4316622; in DE-A-4316876; in EP-A-0589839 or EP-A-0591102, or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, Irganox® HP-136 from Ciba Specialty Chemicals, and 3-(2,3-dimethylphenyl)-5,7-di-tert-butyl-benzofuran-2-one.

Group q) of the thiosynergists includes for example dilauryl thiodipropionate or distearyl thiodipropionate.

Group r) of the peroxide scavengers includes for example esters of β-thiodipropionic acid, for example, the lauryl, stearyl, myristyl or tridecyl ester, mercaptobenzimidazole or the zinc salt of 2-mercaptobenzimidazole, zinc dibutyldithiocarbamate, dioctadecyl disulfide, and pentaerythritol tetrakis(β-dodecylmercapto)propionate.

Group s) of the polyamine stabilizers includes, for example, copper salts in combination with iodides and/or phosphorus compounds and manganese(II) salts.

Group t) of the basic costabilizers includes for example melamine, polyvinylpyrrolidone, dicyandiamide, triallylcyanurate, urea derivatives, hydrazine derivatives, amines, polyamides, polyurethanes, alkali metal and alkaline earth metal salts of higher fatty acids, for example, calcium stearate, zinc stearate, magnesium behenate, magnesium stearate, sodium ricinoleate, and potassium palmitate, antimony pyrocatecholate or zinc pyrocatecholate.

Examples of suitable antistats include amine derivatives, such as N,N-bis(hydroxyalkyl)alkylamines or -alkyleneamines, polyethylene glycol esters and ethers, ethoxylated carboxylic esters and carboxamides, and glycerol monostearates and distearates, and also mixtures thereof.

Suitable fillers or reinforcing materials comprise, for example, calcium carbonate, silicates, talc, mica, kaolin, barium sulfate, metal oxides and metal hydroxides, carbon black, graphite, wood flour and flours or fibers of other natural products, and synthetic fibers. Examples of suitable fibrous or powder fillers further include carbon fibers or glass fibers in the form of glass fabrics, glass mats or filament glass rovings, chopped glass, glass beads, and wollastonite. Glass fibers can be incorporated either in the form of short glass fibers or in the form of continuous fibers (rovings).

Examples of suitable inorganic coloring pigments are white pigments such as titanium dioxide in its three modifications of rutile, anatase or brookite, lead white, zinc white, zinc sulfide or lithopones; black pigments such as carbon black, black iron oxide, iron manganese black or spinel black; chromatic pigments such as chromium oxide, chromium oxide hydrate green, cobalt green or ultramarine green, cobalt blue, iron blue, Milori blue, ultramarine blue or manganese blue, ultramarine violet or cobalt and manganese violet, red iron oxide, cadmium sulfoselenide, molybdate red or ultramarine red; brown iron oxide, mixed brown, spinel phases and corundum phases or chromium orange; yellow iron oxide, nickel titanium yellow, chromium titanium yellow, cadmium sulfide, cadmium zinc sulfide, chromium yellow, zinc yellow, alkaline earth metal chromates, Naples yellow; bismuth vanadate, effect pigments such as interference pigments and luster pigments. Examples of suitable organic pigments are aniline black, anthrapyrimidine pigments, azomethine pigments, anthraquinone pigments, monoazo pigments, disazo pigments, benzimidazolone pigments, quinacridone pigments, quinophthalone pigments, diketopyrrolopyrrole pigments, dioxazine pigments, flavanthrone pigments, indanthrone pigments, indolinone pigments, isoindoline pigments, isoindolinone pigments, thioindigo pigments, metal complex pigments, perinone pigments, perylene pigments, pyranthrone pigments, phthalocyanine pigments, thioindigo pigments, triarylcarbonium pigments or metal complex pigments. Some of the specified pigments, such as carbon black or titanium dioxide, for example, also have the capacity to function as a filler or reinforcing material and/or as a nucleating agent.

Examples of suitable dyes are: azo dyes, pyrazolone dyes, anthraquinone dyes, perinone dyes, perylene dyes, indigo and thioindigo dyes, and azomethine dyes.

Suitable nucleating agents include, for example, inorganic substances, such as talc, metal oxides, such as titanium dioxide or magnesium oxide, phosphates, carbonates or sulfates, preferably of alkaline earth metals; organic compounds, such as monocarboxylic or polycarboxylic acids and the salts thereof, such as 4-tert-butylbenzoic acid, adipic acid, diphenyl acetic acid, sodium succinate or sodium benzoate; and polymeric compounds, such as ionic copolymers (ionomers). Particular preference is given to 1,3-;2,4-bis(3′,4′-dimethylbenzylidene)sorbito, 1,3-;2,4-di(para-methyldibenzylidene)sorbitol, and 1,3-;2,4-di(benzylidene)sorbitol.

When used, compounds of groups a) to t), with the exception of the benzofuranones of group p), are present in the composition of the invention typically in amounts from 0.0001% to 10% by weight, preferably from 0.01% to 1% by weight, based on the total weight of the composition.

Further typical additives are lubricants. As lubricants the composition of the invention may comprise all of the lubricants that are typical for the processing of plastics. Suitability is possessed by hydrocarbons such as oils, paraffins, and polyethylene waxes; fatty alcohols, preferably having 6 to 20 C atoms; ketones; carboxylic acids, such as fatty acids (e.g., montanic acid); oxidized polyethylene waxes; metal salts of carboxylic acids; carboxamides and also carboxylic esters; the alcohol component is selected for example from ethanol, fatty alcohols, glycerol, ethanediol and pentaerythritol, and the carboxylic acid component from, for example, long-chain carboxylic acids.

In order to reduce the flammability and to reduce the amount of smoke given off on burning, the composition of the invention may also comprise flame inhibitors (flame retardants). Examples of suitable flame retardants are organic chlorine and bromine compounds, such as chlorinated paraffins, antimony trioxide, phosphorus compounds such as phosphate esters, aluminum hydroxide, boron compounds, molybdenum trioxide, ferrocene, calcium carbonate or magnesium carbonate. Preferred flame retardants are the hydroxides, oxides, and oxide hydrates of the (semi)metals of groups 2, 4, 12, 13, 14, and 15, and also nitrogen-based and phosphorus-based flame retardants. Examples of hydroxides, oxides, and oxide hydrates of the (semi)metals of groups 2, 4, 12, 13, 14, and 15 are magnesium oxide, magnesium hydroxide, aluminum oxide, aluminum trihydrate, silicon dioxide, tin oxide, antimony(III and V) oxide, antimony(III and V) oxide hydrate, titanium dioxide, zinc oxide, and zinc oxide hydrate. Examples of nitrogen-based flame retardants are melamine resins and urea resins, melamine cyanurate, and melamine borate. Examples of phosphorus-based flame retardants are red phosphorus, ammonium polyphosphates, phosphoric esters, more particularly triaryl phosphates, such as triphenyl phosphate, tribenzyl phosphate, tricresyl phosphate, tri(dimethylphenyl) phosphate, benzyl dimethyl phosphate, di-(dimethylphenyl)phenyl phosphate, resorcinol bis(diphenyl phosphate), resorcinol bis-[di-(2,6-dimethylphenyl)phosphate] (PX-200), aluminum diethylphosphinate (Exolit® OP 1230), and also aliphatic phosphates, such as tris(2-chloroisopropyl) phosphate (Lupragen® TCPP), aromatic polyphosphates, examples being phosphates derived from bisphenols, such as the compounds described in US 2004/0249022, and phosphonic esters, such as dimethyl methylphosphonate and (2-((hydroxymethyl)carbamyl)ethyl)dimethyl phosphonate, and polycyclic phosphorus-containing compounds, such as 9,10-dihydro-9-oxa-10-phosphaphenanthrene 10-oxide (DOPO).

The choice of suitable conventional additives for the composition of the invention is dependent on the particular end use of the cured epoxy resins and can be determined in each individual case by the skilled worker.

Further provided by the invention is a prepreg comprising the composition of the invention. A prepreg (preimpregnated fibers) is an uncured, fiber-reinforced, thermoset, semifinished product, i.e., a fiber mat impregnated with an uncured or only part-cured epoxy resin (including curative). In the prepreg of the invention a fiber mat is impregnated with the composition of the invention. Suitable fiber materials comprise surface-treated glass fibers, quartz fibers, boron fibers, and graphite fibers (carbon fibers), and also fibers of certain aromatic polyamides, which are also referred to as polyaramids (e.g., Kevler® from DuPont). More particular preference among these is given to glass fibers.

The invention further provides a cured epoxy resin obtainable by curing uncured or part-cured epoxy resin with a condensation product (i), (ii), (iii), (iv), (v) or (vi) as defined above and, optionally, at least one conventional curative for epoxy resins, or by curing a composition of the invention or a prepreg of the invention.

With regard to suitable and preferred condensation products, conventional curatives, epoxy resins, and curing conditions, and also to the composition of the invention and the prepreg of the invention, reference is made to the observations above.

In one embodiment the cured epoxy resin comprises a reinforcement. Such a resin is also referred to as a composite.

Composites, or composite materials, are complex materials comprising two or more different substances, and have properties that are not present in the individual substances. In epoxy composites, one of the substances is an epoxy resin. The term embraces not only heterogeneous mixtures of epoxy resins with other materials, such as minerals, fibers, other plastics or elastomers, but also homogeneous (single-phase) mixtures of epoxy resins with one or more polymers, also referred to as a homogeneous polymer blend. (Heterogeneous) epoxy composites generally comprise a fiber as reinforcing material. Epoxy composites based on fibers are generally produced by disposing strong, continuous fibers in an epoxy resin/curative matrix. Suitable fiber materials include surface-treated glass fibers, quartz fibers, boron fibers, and graphite fibers (carbon fibers), and fibers of certain aromatic polyamides, also referred to as polyaramids (e.g., Kevler® from DuPont).

Examples of composites are what are known as prepregs (preimpregnated fibers). A prepreg is an uncured, fiber-reinforced, thermoset, semi-finished product, i.e., a fiber mat, which is impregnated with uncured or part-cured epoxy resin (including curative).

Further examples are composites which are obtained by winding. For this purpose a fiber, a wire for example, which has been impregnated with an uncured or part-cured epoxy resin (including curative), is wound to a roll.

Further examples are composite boards, such as chipboard, fiberboard and rigid-fiberboard, which generally comprise finely divided pieces of wood, such as wood chips or wood fibers, as a filler.

Another important example of epoxy composites are epoxy laminates, more particularly printed circuit boards (PCBs), which are employed in computers and electronic devices. Electrical laminates are generally produced from glass fabric laminate (low-alkali glass), which is impregnated with an uncured or part-cured epoxy resin (including curative) and so forms a prepreg. A multilayer laminate is then put together from a plurality of layers of prepregs and one or more layers of copper foil. This structure is then cured, preferably with exposure to high temperatures (150-180° C.) and pressures (2-10 MPa). The cure time depends on the particular composition of the laminate, the thickness and number of the layers, the epoxy resin, and the curative, and is determined by the skilled worker on an ad hoc basis.

In one preferred embodiment of the invention, the cured epoxy resin comprises, as reinforcing material, glass fibers, boron fibers, carbon fibers or polyaramid fibers, and more particularly glass fibers.

In another preferred embodiment the cured epoxy resin is a laminate constructed from at least two prepregs of the invention. The laminate preferably further comprises a copper foil. Within the laminate the epoxy resin is present in cured form.

In another preferred embodiment the cured epoxy resin of the invention comprises a filler, the filler being selected preferably from minerals and particulate wood, such as wood chips and wood fibers.

The invention provides, finally, a method of curing an epoxy resin by admixing an uncured or part-cured epoxy resin with at least one condensation product (i), (ii), (iii), (iv), (v), or (vi) as defined above and, optionally, with at least one conventional epoxy resin curative and bringing the resulting mixture to a temperature of 5 to 150° C. or subjecting it to microwave radiation.

With regard to suitable and preferred condensation products, conventional curatives, epoxy resins, and curing conditions, such as temperature, reference is made to the observations above.

The use of at least one of the condensation products (i) to (vi) as curatives produces cured epoxy resins having a very high crosslinking density, without the need to use toxic, volatile or foul-smelling curatives. The resulting thermosets are distinguished by high mechanical and chemical stability and their possible uses are extremely diverse.

The invention is now elucidated in greater detail by the nonlimiting examples which follow.

### EXAMPLES

### 1.) Preparation of the Condensation Products

### 1.1) Polymer of melamine and N,N-bis(3-aminopropyl)ethylenediamine

778.7 g (4.5 mol) of N,N-bis(3-aminopropyl)ethylenediamine, 40.1 g of ammonium chloride, and 50.4 g (0.4 mol) of melamine were mixed and the mixture was heated slowly to 200° C. under nitrogen. During the heating operation, gas was given off (ammonia). When the melamine had fully dissolved, the mixture was cooled to 100° C., 50.4 g (0.4 mol) of melamine were added, and the mixture was again heated to 200° C. This procedure was repeated until a total of 189 g (1.5 mol) of melamine had been added. The reaction mixture was maintained at 200° C. under nitrogen until the viscosity (23° C.) had reached about 50 000 mPa·s. The resulting viscous brown oil was admixed slowly at 75° C. with 69.4 g of NaOH (in the form of a 50% strength aqueous solution) and the precipitate formed was removed by filtration. This gave an oil having the following properties:

Mₙ: 2700; M_{w}: 6000; PD: 2.2; amine number: 539 mg KOH/g; viscosity (23° C.): 6430 mPa·s

### 1.2) Polymer of melamine and isophoronediamine

927.2 g (5.4 mol) of isophoronediamine, 5.22 g of ammonium chloride, and 49.1 g (0.4 mol) of melamine were mixed and the mixture was heated slowly to 200° C. under nitrogen. During the heating operation, gas was given off (ammonia). When the melamine had fully dissolved, the mixture was cooled to 100° C., 49.1 g (0.4 mol) of melamine were added, and the mixture was again heated to 200° C. This procedure was repeated until a total of 245.5 g (1.9 mol) of melamine had been added. The reaction mixture was maintained at 200° C. for 40.5 h. Cooling to room temperature gave a beige, glasslike solid having the following properties:

Mₙ,: 5000; M_{w}: 9500; PD: 1.9; amine number: 368 mg KOH/g

### 1.3) Polymer of melamine and hexamethylenediamine

325.6 g (2.8 mol) of hexamethylenediamine, 5.35 g of ammonium chloride, and 25.2 g (0.2 mol) of melamine were mixed and the mixture was heated slowly to 200° C. under nitrogen. During the heating operation, gas was given off (ammonia). When the melamine had fully dissolved, the mixture was cooled to 100° C., 25.2 g (0.2 mol) of melamine were added, and the mixture was again heated to 200° C. This procedure was repeated until a total of 126 g (1.0 mol) of melamine had been added. The reaction mixture was maintained at 200° C. under nitrogen until the viscosity (50° C.) had reached about 35 000 mPa·s. Cooling to room temperature gave an oil having the following properties:

Mₙ: 2300; M_{w}: 6800; PD: 3.0; amine number: 517 mg KOH/g; viscosity (50° C.): 36 100 mPa·s

### 1.4) Polymer of diethyl carbonate and diethylenetriamine

1349 g (11.4 mol) of diethyl carbonate and 1178 (11.4 mol) of diethylenetriamine were charged to a 4 I flask and the mixture was heated to 135° C. Following the onset of reaction, the temperature fell, owing to the evolution of ethanol, to about 108° C. The ethanol formed was removed by distillation on a 20 cm Vigreux column. Cooling to room temperature gave a product having the following properties:

Mₙ: 960; M_{w}: 1400; PD: 1.5; amine number: 484 mg KOH/g

### 1.5) Polymer of urea and tris(2-aminopropyl)amine

161 g (2.7 mol) of urea and 503 g (2.7 mol) of tris(2-aminopropyl)amine were charged to a 1 I flask and mixed and the mixture was heated to 100° C. Following the onset of reaction, ammonia formed was taken off and neutralized by introduction into an aqueous HCl solution with a strength of approximately 32%. The reaction mixture was heated to 150° C. over the course of 3 h. Cooling to room temperature gave a product having the following properties:

Mₙ: 2700; M_{w}: 4100; PD: 1.5; amine number: 643 mg KOH/g

### 1.6) Polymer of urea, melamine, and hexamethylenediamine

929.6 g (8 mol) of hexamethylenediamine, 50.4 g (0.4 mol) of melamine, and 5.35 g (0.1 mol) of ammonium chloride were heated slowly to 200° C. under nitrogen. After all of the melamine had dissolved, the mixture was cooled to 100° C., 50.4 g (0.4 mol) of melamine were added, and the mixture was again heated to 200° C. This procedure was repeated until a total of five 50.4 g portions of melamine (total amount of melamine 252 g, 2 mol) had been added. The reaction mixture was maintained at 200° C. under nitrogen for 58 hours. It was then cooled to 50° C. and 60 g (1 mol) of urea were added in 3 20 g portions. Thereafter the mixture was heated to 120° C. and maintained at that temperature until the urea had dissolved and the evolution of ammonia had subsided. The reaction mixture was maintained under nitrogen at 120° C. until it had a viscosity of 6000 mPas at 75° C. This gave a yellowish, highly viscous, virtually immobile oil having the following properties:

Mₙ: 2400; M_{w}: 8800; PD: 3.7; amine number: 461 mg KOH/g

### 1.7) Synthesis of N,N′,N″-tris(6-aminohexyl)melamine

63.5 g (0.5 Mol) of melamine, 1162 g (10.0 mol) of hexamethylenediamine, and 26.8 g (0.5 Mol) of ammonium chloride were boiled under reflux (about 210° C.), with stirring and the passage of a gentle stream of nitrogen over the mixture, for 14-16 h. Then, at 100° C., 48 g (0.6 mol) of 50% strength aqueous sodium hydroxide solution were added and the precipitated salt was filtered off hot. Finally the hexamethylenediamine excess was removed from the filtrate by vacuum distillation, to give 211 g of a colorless, viscous oil. According to quantitative HPLC analysis, the product contained 92% by weight N,N′,N″-tris-(6-aminohexyl)melamine.

Amine number: 496 mg KOH/g

### 2.) Curing of Epoxy Resins

The products from the preparation examples were employed either as they were or combined with a mixture of 70% by weight Jeffamine D-230 (polyetheramine from Huntsman Corp.; difunctional, amine-terminated polyetherol; Mₙ about 230 g/mol) and 30% by weight isophoronediamine, this mixture being referred to below as D-230/IPDA.

The resin used was Epilox® A 19-00 (Leuna-Harze GmbH; Leuna, Germany) (epoxide equivalent according to DIN 16 945: 182-192 g/equiv.; viscosity (25° C.) according to DIN 53 015 9000-13 000 mPa·s; density (20° C.) according to DIN 53 217 T.4 1.17 g/cm³; Gardner color number; DIN ISO 4630 <2).

### General Procedure

1 g of the product from one of the above preparation examples, or a mixture thereof with D-230/IPDA in the weight proportion indicated below, was admixed with Epilox® A 19-00. The amount of Epilox was chosen such that there was one reactive hydrogen atom per epoxide equivalent. The number of reactive protons was calculated from the amine number in accordance with DIN 16945.

The mixture was poured into different molds, degassed in an ultrasound bath at room temperature, and cured in a drying cabinet at 40° C. for 16 h.

All of the cured products were hard and clear or slightly opaque.

2.1) Curative: product from example 1.1
Amount of curative: 5 g

### Amount of Epilox®: 17.50 g

Cured product: pale yellow, clear
2.2) Curative: mixture: 10% by weight product from example 1.1 and 90% by weight D-230/IPDA. The mixture had an amine number of 513 mg KOH/g
Amount of curative: 5 g

### Amount of Epilox®: 16.65 g

Cured product: colorless, cloudy
2.3) Curative: mixture: 10% by weight product from example 1.2 and 90% by weight D-230/IPDA. The mixture had an amine number of 495 mg KOH/g
Amount of curative: 5 g

### Amount of Epilox®: 16.05 g

Cured product: colorless, cloudy
2.4) Curative: mixture: 10% by weight product from example 1.3 and 90% by weight D-230/IPDA. The mixture had an amine number of 505 mg KOH/g
Amount of curative: 5 g

### Amount of Epilox®: 16.40 g

Cured product: colorless, slightly cloudy
2.5) Curative: product from example 1.4
Amount of curative: 5 g

### Amount of Epilox®: 15.70 g

Cured product: yellow, clear
2.6) Curative: mixture: 10% by weight product from example 1.4 and 90% by weight
D-230/IPDA. The mixture had an amine number of 507 mg KOH/g
Amount of curative: 5 g

### Amount of Epilox®: 16.45 g

Cured product: colorless, clear
2.7) Curative: product from example 1.5
Amount of curative: 5 g

### Amount of Epilox®: 20.90 g

Cured product: colorless, cloudy
2.8) Curative: mixture: 5% by weight of product from example 1.5 and 95% by weight
D-230/IPDA. The mixture had an amine number of 516 mg KOH/g
Amount of curative: 5 g

### Amount of Epilox®: 16.75 g

Cured product: colorless, clear
2.9) Curative: product from example 1.7
Amount of curative: 5 g

### Amount of Epilox®: 16.10 g

Cured product: colorless, clear
2.10) Curative: mixture: 10% by weight of product from example 1.7 and 90% by weight D-230/IPDA. The mixture had an amine number of 508 mg KOH/g
Amount of curative: 5 g

### Amount of Epilox®: 16.50 g

Cured product: colorless, clear
2.11) Curative: product from example 1.1; comparison: D-230/IPDA

The cured product produced with the curative from example 1.1 had a significantly higher T_{g} than the product cured with D-230/IPDA (139° C. vs. 108° C.).

2.12) Curative: product from example 1.5; comparison: D-230/IPDA

With the product from example 1.5, curing already set in at a significantly lower temperature than in the case of use of D-230/IPDA (33° C. vs. 77° C.).

1. A curative for an epoxy resin comprising a condensation product selected from
(i) a highly branched polymer obtained by a process comprising condensing
(i-1) urea and/or at least one urea derivative; and
(i-2) at least one amine having at least two primary and/or secondary amino groups, with at least one amine comprising at least three primary and/or secondary amino groups;
(ii) a highly branched polymer obtained by a process comprising condensing
(ii-1) one amine having at least three primary and/or secondary amino groups, or at least two amines having at least two primary and/or secondary amino groups, with at least one of these at least two amines comprising at least three primary and/or secondary amino groups;
(iii) a highly branched polymer obtained by a process comprising condensing
(iii-1) at least one at least difunctional di- or polyisocyanate; and
(iii-2) at least one amine having at least two primary and/or secondary amino groups, with at least one polyisocyanate being at least trifunctional or with at least one amine comprising at least three primary and/or secondary amino groups;
(iv) a highly branched polymer obtained by a process comprising condensing
(iv-1) at least one carboxylic acid having at least two carboxyl groups or at least one derivative thereof; and
(iv-2) at least one amine having at least two primary and/or secondary amino groups;
with at least one carboxylic acid comprising at least three carboxyl groups or carboxyl group derivatives, or with at least one amine comprising at least three primary and/or secondary amino groups;
(v) an oligomeric compound obtained by a process comprising condensing
(v-1) urea and/or at least one urea derivative; and
(v-2) at least one amine having at least two primary and/or secondary amino groups, with at least one amine comprising at least three primary and/or secondary amino groups; and
(vi) an oligomeric compound obtained by a process comprising condensing
(vi-1) melamine; and
(vi-2) at least one amine having at least two primary and/or secondary amino groups and being different than melamine.

2. The curative of claim 1, wherein the urea derivatives of components (i-1) and (v-1) are
substituted ureas of formula R¹R²N—C(═O)—NR³R⁴, in which R¹, R², R³, and R⁴ independently of one another are selected from the group consisting of hydrogen, C₁-C₁₂-alkyl, aryl, and aryl-C₁-C₄-alkyl, with at least one of the radicals R¹, R², R³, and R⁴ not being hydrogen; or R¹ and R² and/or R³ and R⁴ each together are C₂-C₅-alkylene, with one methylene group optionally being replaced by a carbonyl group; or R¹ and R³ together are C₂-C₅-alkylene, with one methylene group optionally being replaced by a carbonyl group; or R¹ and R² and/or R³ and R⁴, in each case together with the nitrogen atom to which they are attached, form a 5- or 6-membered unsaturated aromatic or nonaromatic ring which may further comprise one or two further nitrogen atoms or a sulfur atom or oxygen atom as ring member;
biuret;
thiourea;
substituted thioureas of formula R⁵R⁶N—C(═S)—NR⁷R⁸, in which R⁵, R⁶, R⁷, and R⁸ independently of one another are selected from the group consisting of hydrogen, C₁-C₁₂-alkyl, aryl, and aryl-C₁-C₄-alkyl, with at least one of the radicals R⁵, R⁵, R⁷, and R⁸ not being hydrogen; or R⁵ and R⁶ and/or R⁷ and R⁸ each together are C₂-C₅-alkylene, with one methylene group optionally being replaced by a carbonyl group; or R⁵ and R⁷ together are C₂-C₅-alkylene, with one methylene group optionally being replaced by a carbonyl group; or R⁵ and R⁶ and/or R⁷ and R⁸, in each case together with the nitrogen atom to which they are attached, form a 5- or 6-membered unsaturated aromatic or nonaromatic ring which may further comprise one or two further nitrogen atoms or a sulfur atom or oxygen atom as ring member;
guanidine;
substituted guanidines of the formula R⁹R¹⁰N—C(═NR¹¹)—NR¹²R¹³, in which R⁹, R¹⁰, R¹¹, R¹² and R¹³ independently of one another are selected from the group consisting of hydrogen, C₁-C₁₂-alkyl, aryl, and aryl-C₁-C₄-alkyl, with at least one of the radicals R⁹, R¹⁰, R¹¹, R¹² and R¹³ not being hydrogen; or R⁹ and R¹⁰ and/or R¹² and R¹³ each together are C₂-C₅-alkylene, with one methylene group optionally being replaced by a carbonyl group; or R⁹ and R¹² together are C₂-C₅-alkylene, with one methylene group optionally being replaced by a carbonyl group; or R⁹ and R¹⁰ and/or R¹² and R¹³, in each case together with the nitrogen atom to which they are attached, form a 5- or 6-membered unsaturated aromatic or nonaromatic ring which may further comprise one or two further nitrogen atoms or one sulfur atom or oxygen atom as ring member; or
carbonic esters of the formula R¹⁴—O—CO—O—R¹⁵, in which R¹⁴ and R¹⁵ independently of one another are selected from the group consisting of C₁-C₁₂-alkyl, aryl, and aryl-C₁ C₄-alkyl, or R¹⁴ and R¹⁵ together are C₂-C₅-alkylene.

3. The curative according to claim 2, wherein R² and R⁴ are hydrogen and R¹ and R³ are identical and are C₁-C₁₂-alkyl, aryl or aryl-C₁-C₄-alkyl; or R¹, R², R³, and R⁴ are identical and are linear C₁-C₄-alkyl; or R¹ and R² and also R³ and R⁴, in each case together, are C₂-C₅-alkylene, with one methylene group optionally being replaced by a carbonyl group; or R² and R⁴ are hydrogen and R¹ and R³ together are C₂-C₅-alkylene, with one methylene group optionally being replaced by a carbonyl group; or R¹ and R² and also R³ and R⁴, in each case together with the nitrogen atom to which they are attached, form a 5- or 6-membered unsaturated aromatic or nonaromatic ring which may further comprise a further nitrogen atom, sulfur atom or oxygen atom as ring member.

4. The curative according to claim 2, wherein R⁶ and R⁸ are hydrogen and R⁵ and R⁷ are alike and are C₁-C₁₂-alkyl, aryl or aryl-C₁-C₄-alkyl; or R⁵, R⁶, R⁷, and R⁸ are alike and are linear C₁-C₄-alkyl; or R⁵ and R⁶ and also R⁷ and R⁸, in each case together, are C₂-C₅-alkylene, with one methylene group optionally being replaced, by a carbonyl group; or R⁶ and R⁸ are hydrogen and R⁵ and R⁷ together are C₂-C₅-alkylene, with one methylene group optionally being replaced by a carbonyl group; or R⁵ and R⁶ and also R⁷ and R⁸, in each case together with the nitrogen atom to which they are attached, form a 5- or 6-membered unsaturated aromatic or nonaromatic ring which may further comprise a further nitrogen atom, sulfur atom or oxygen atom as ring member.

5. The curative according to claim 2, wherein R¹⁰, R¹¹, and R¹³ are hydrogen and R⁹ and R¹² are identical and are C₁-C₁₂-alkyl, aryl or aryl-C₁-C₄-alkyl; or R⁹, R¹⁰, R¹², and R¹⁴ are identical and are linear C₁-C₄-alkyl and R¹¹ is H or methyl; or R⁹ and R¹⁰ and also R¹² and R¹³ in each case together are C₂-C₅-alkylene, with one methylene group optionally being replaced by a carbonyl group, and R¹¹ is H or methyl; or R¹⁰, R¹¹, and R¹³ are hydrogen and R⁹ and R¹² together are C₂-C₅-alkylene, with one methylene group optionally being replaced by a carbonyl group; or R⁹ and R¹⁰ and also R¹² and R¹³, in each case together with the nitrogen atom to which they are attached, form a 5- or 6-membered unsaturated aromatic or nonaromatic ring which may further comprise a further nitrogen atom, sulfur atom or oxygen atom as ring member, and R¹¹ is H or methyl.

6. The curative according to claim 2, wherein R¹⁴ and R¹⁵ are alike and are C₁-C₄-alkyl.

7. The curative according to claim 1, wherein said at least one amine having at least two primary and/or secondary amino groups, of components (i-2), (ii-1), (iii-2), (iv-2), (v-2), and (vi-2), is selected from the group consisting of amines of the formula I
NHR^{a}-A-NHR^{b} (I)
in which
A is a divalent aliphatic, alicyclic, aliphatic-alicyclic, aromatic or araliphatic radical, with the aforementioned radicals also optionally being interrupted by a carbonyl group or by a sulfone group and/or possibly substituted by 1, 2, 3 or 4 radicals selected from C₁-C₄-alkyl; or is a divalent radical of the formula
B—Xₘ—B—
in which
each X independently is O or NR^{c}, in which R^{c} is H, C₁-C₄-alkyl, C₂-C₄-hydroxyalkyl or C₁-C₄-alkoxy;
each B independently is C₂-C₆-alkylene; and
m is a number from 1 to 100; and
R^{a} and R^{b} independently of one another are H, C₁-C₄-alkyl, C₂-C₄-hydroxyalkyl or C₁-C₄-alkoxy.

8. The curative according to claim 7, wherein the divalent aliphatic radicals A are linear or branched C₂-C₂₀-alkylene.

9. The curative according to claim 7, wherein the divalent alicyclic radicals A are selected from C₅-C₈-cycloalkylene which optionally comprise 1, 2, 3 or 4 C₁-C₄-alkyl radicals.

10. The curative according to claim 7, wherein the divalent aliphatic-alicyclic radicals A are selected from C₅-C₈-cycloalkylene-C₁-C₄-alkylene, C₅-Cₛ-cycloalkylene-C₁-C₄-alkylene-C₅-C₈-cycloalkylene, and C₁-C₄-alkylene-C₅-C₈-cycloalkylene-C₁-C₄-alkylene, with the cycloalkylene radicals optionally comprising 1, 2, 3 or 4 C₁-C₄-alkyl radicals.

11. The curative according to claim 7, wherein the divalent aromatic radicals A are selected from phenylene, naphthylene, biphenylene, phenylene-sulfone-phenylene, and phenylene-carbonyl-phenylene, with the phenylene radicals optionally comprising 1, 2, 3 or 4 C₁-C₄-alkyl radicals.

12. The curative according to claim 7, wherein the divalent araliphatic radicals A are selected from phenylene-C₁-C₄-alkylene and phenylene-C₁-C₄-alkylene-phenylene, with the phenylene radicals optionally comprising 1, 2, 3 or 4 C₁-C₄-alkyl radicals.

13. The curative according to claim 1, wherein said at least one amine having at least three primary and/or secondary amino groups, of components (i-2), (ii-1), (iii-2), (iv-2), and (v-2), is selected from the group consisting of
amines of the formula I.a
NHR^{a}1-A¹-NHR^{b1} (I.a)
in which
A¹ is a divalent radical of the formula
B¹—X¹ₘ₁—B¹—;
in which
each X¹ independently is O or NR^{c1}, with at least one X¹ in the compound I.a being NR^{c1}, in which R^{c1} is H, C₁-C₄-alkyl, C₂-C₄-hydroxyalkyl or C₁-C₄-alkoxy, with at least one radical R^{c1} being H;
each B¹ independently is C₂-C₆-alkylene; and
m¹ is a number from 1 to 20; and
R^{a1} and R^{b1} independently of one another are H, C₁-C₄-alkyl, C₂-C₄-hydroxyalkyl or C₁-C₄-alkoxy;
amines of the formula II 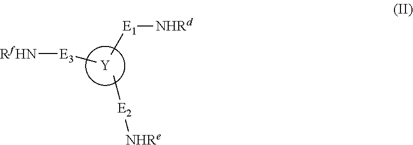
in which
Y is CR⁹, N, C₂-C₆-alkyl, C₃-C₆-cycloalkyl, phenyl or a 5- or 6-membered, saturated, partly unsaturated or aromatic heterocyclic ring having 1, 2 or 3 heteroatoms as ring members which are selected from the group consisting of N, O, and S;
E₁, E₂, and E₃ independently of one another are a single bond, C₁-C₁₀-alkylene, NR^{h}—C₂-C₁₀-alkylene or O—C₁-C₁₀-alkylene, with the proviso that E₁, E₂, and E₃ are not a single bond and not —NR^{h}—C₂-C₁₀-alkylene if Y is N;
R^{d}, R^{e} and R^{f} independently of one another are H, C₁-C₄-alkyl, C₂-C₄-hydroxyalkyl or C₁-C₄-alkoxy; and
R^{g} and R^{h} independently of one another are H, C₁-C₄-alkyl, C₂-C₄-hydroxyalkyl or C₁-C₄-alkoxy;
amines of the formula III 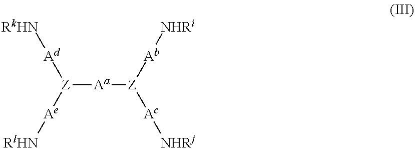
in which
A^{a} has one of the definitions stated for A in any one of claims 7 to 12;
A^{b}, A^{c}, A^{d}, and A^{e} independently of one another are C₁-C₁₀-alkylene;
Z is N or CR^{m}; and
Rⁱ, R^{j}, R^{k}, R^{l}, and R^{m} independently of one another are H, C₁-C₄-alkyl, C₂-C₄-hydroxyalkyl or C₁-C₄-alkoxy; and
mixtures thereof.

14. The curative according to claim 1, wherein said at least one amine having at least three primary and/or secondary amino groups, of components (i-2) and (ii-1), comprises melamine.

15. The curative according to claim 1, wherein said at least one amine having at least three primary and/or secondary amino groups, of component (ii-1), comprises no melamine.

16. The curative according to claim 1, wherein the condensation products (i) are selected from the group consisting of
(i) highly branched polymers obtained by a process comprising condensing
(i-1) urea and/or at least one urea derivative;
(i-2a) melamine;
(i-2b) at least one amine, with the at least one amine comprising
(i-2ba) 20 to 100 mol %, based on the total amount of components (i-2ba), (i-2bb), and (i-2bc), of at least one diamine or polyamine having two primary amino groups,
(i-2bb) 0 to 50 mol %, based on the total amount of components (i-2ba), (i-2bb), and (i-2bc), of at least one polyamine having at least three primary amino groups and being different than melamine; and
(i-2bc) 0 to 80 mol %, based on the total amount of components (i-2ba), (i-2bb), and (i-2bc), of at least one amine having one primary amino group;
and
(i-2c) optionally, at least one melamine derivative selected from the group consisting of benzoguanamine, a substituted melamine melamines, and a melamine condensate.

17. The curative according to claim 16, wherein component (i-1) is urea.

18. The curative according to claim 16, wherein the diamine or polyamine of component (i-2ba) is selected from the group consisting of amines of the formula I
NH₂-A-NH₂ (I)
wherein
A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula
B—Xₘ—B—
in which
each X independently is O or NR^{C}, in which R^{c} is H, C₁-C₄-alkyl, C₂-C₄-hydroxyalkyl or C₁-C₄-alkoxy;
each B independently is C₂-C₆-alkylene; and
m is a number from 1 to 100; and
R^{a} and R^{b} independently of one another are H, C₁-C₄-alkyl, C₂-C₄-hydroxyalkyl or C₁-C₄-alkoxy.

19. The curative according to claim 16, wherein component (i-2b) is a diamine having two primary amino groups.

20. The curative according to claim 19, wherein the diamine having two primary amino groups is selected from the group consisting of C₂-C₂₀-alkylenediamines.

21. The curative according to claim 1, wherein the condensation products (i) are selected from the group consisting of
(i) highly branched polymers obtained by a process comprising condensing
(i-1) urea and/or at least one urea derivative;
(i-2d) at least one amine having at least three primary and/or secondary amino groups which is different than melamine; and
(i-2e) optionally, at least one amine having two primary and/or secondary amino groups.

22. The curative according to claim 21, wherein component (i-1) is urea or at least one substituted urea of the formula R¹R²N—C(═O)—NR³R⁴, in which R¹, R², R³, and R⁴ independently of one another are selected from hydrogen, C₁-C₁₂-alkyl, aryl, and aryl-C₁-C₄-alkyl, with at least one of the radicals R¹, R², R³, and R⁴ not being hydrogen; or R¹ and R² and/or R³ and R⁴ each together are C₂-C₅-alkylene, with one methylene group optionally being replaced by a carbonyl group; or R¹ and R³ together are C₂-C₅-alkylene, with one methylene group optionally being replaced by a carbonyl group; or R¹ and R² and/or R³ and R⁴, in each case together with the nitrogen atom to which they are attached, form a 5- or 6-membered unsaturated aromatic or nonaromatic ring which may further comprise one or two further nitrogen atoms or a sulfur atom or oxygen atom as the ring member.

23. The curative according to claim 21, wherein component (i-1) is at least one carbonic ester of the formula R¹⁴—O—CO—O—R¹⁵, in which R¹⁴ and R¹⁵ independently are selected from C₁-C₁₂-alkyl, aryl, and aryl-C₁ C₄-alkyl, or R¹⁴ and R¹⁵ together are C₂-C₅-alkylene.

24. The curative according to claim 21, wherein component (i-1) guanidine or at least one substituted guanidine of the formula R⁹R¹⁰N—C(═NR¹¹)—NR¹²R¹³, in which R⁹R¹⁰, R¹¹, R¹², and R¹³ independently are selected from the group consisting of hydrogen, C₁-C₁₂-alkyl, aryl, and aryl-C₁-C₄-alkyl, with at least one of the radicals R⁹, R¹⁰, R¹¹, R¹², and R¹³ not being hydrogen; or R⁹ and R¹⁰ and/or R¹² and R¹³ each together are C₂-C₅-alkylene, with one methylene group optionally being replaced by a carbonyl group; or R⁹ and R¹² together are C₂-C₅-alkylene, with one methylene group optionally being replaced by and a carbonyl group; or R⁹ and R¹⁰ and/or R¹² and R¹³, in each case together with the nitrogen atom to which they are attached, form a 5- or 6-membered unsaturated aromatic or nonaromatic ring which may further comprise one or two further nitrogen atoms or one sulfur atom or oxygen atom as ring member.

25. The curative according to claim 21, wherein said at least one amine of component (i-2d) is selected from amines of the formula I.a and amines of the formula II
wherein
NHR^{a1}-A¹-NHR^{b1} (I.a)
in which
A¹ is a divalent radical of the formula
B¹—X¹ₘ—B¹—;
in which
each X¹ independently is O or NR^{C1}, with at least one X¹ in the compound I.a being NR^{c1}, in which R^{c1} is H, C₁-C₄-alkyl, C₂-C₄-hydroxyalkyl or C₁-C₄-alkoxy, with at least one radical R^{c1} being H;
each B¹ independently is C₂-C₆-alkylene; and
m¹ is a number from 1 to 20; and
R^{a1} and R^{b1} independently of one another are H, C₁-C₄-alkyl, C₁-C₄-hydroxyalkyl or C₁-C₄-alkoxy;
amines of the formula II 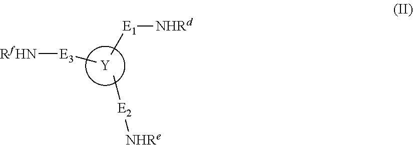
in which
Y is CR⁹, N, C₁-C₆-alkyl, C₃-C₆-cycloalkyl, phenyl or a 5- or 6-membered, saturated, partly unsaturated or aromatic heterocyclic ring having 1, 2 or 3 heteroatoms as ring members which are selected from the group consisting of N, O, and S;
E₁, E₂ and E₃ independently of one another are a single bond, C₁-C₁₀-alkylene, NR^{h}-C₂-C₁₀-alkylene or O—C₁-C₁₀-alkylene, with the proviso that E₁, E₂ and E₃ are not a single bond and not —NR^{h}—C₂-C₁₀-alkylene if Y is N;
R^{d}, R^{e} and R^{f} independently of one another are H, C₁-C₄-alkyl, C₁-C₄-hydroxyalkyl or C₁-C₄-alkoxy; and
R^{g} and R^{h} independently of one another are H, C₁-C₄-alkyl, C₂-C₄-hydroxyalkyl or C₁-C₄-alkoxy.

26. The curative according to claim 21, wherein said at least one amine of component (i-2e) is selected from amines of the formula I
NHR^{a}-A-NHR^{b} (I)
in which
A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula
{B—X}ₘ—B—
in which
each X independently is O or NR^{C}, in which R^{C} is H, C₁-C₄-alkyl, C₂-C₄-hydroxyalkyl or C₁-C₄-alkoxy;
each B independently is C₂-C₆-alkylene; and
m is a number from 1 to 100; and
R^{a} and R^{b} independently of one another are H, C₁-C₄-alkyl, C₂-C₄-hydroxyalkyl or C₁-C₄-alkoxy, with the proviso that R^{C} is not H.

27. The curative according to claim 1, wherein the highly branched polymers (ii) are obtained by a process comprising condensing
(ii-1a) at least one amine having at least three primary and/or secondary amino groups; and
(ii-1b) at least one amine having at least two primary and/or secondary amino groups.

28. The curative according to claim 27, wherein the highly branched polymers (ii) are obtained by a process comprising condensing
(ii-1aa) melamine;
(ii-1b) at least one amine having at least two primary and/or secondary amino groups; and
(ii-c) optionally, at least one amine having one primary amino group.

29. The curative according to claim 27, wherein said at least one amine having at least two primary and/or secondary amino groups, of component (ii-1b), is selected from amines of the formula I
NHR^{a}-A-NHR^{b} (I)
in which A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula
{B—X}ₘ—B—
in which
each X independently is O or NR^{c}, in which R^{c} is H, C₁-C₄-alkyl, C₂-C₄-hydroxyalkyl or C₁-C₄-alkoxy;
each B independently is C₂-C₆-alkylene; and
m is a number from 1 to 100; and
R^{a} and R^{b} independently of one another are H, C₁-C₄-alkyl, C₂-C₄-hydroxyalkyl or C₁-C₄-alkoxy.

30. The curative according to claim 27, wherein component (ii-1a) comprises no melamine.

31. The curative according to claim 1, wherein component (v-1) is urea or at least one substituted urea of the formula R¹R²N—C(═O)—NR³R⁴, in which R¹, R², R³, and R⁴ independently of one another are selected from hydrogen, C₁-C₁₂-alkyl, aryl, and aryl-C₁-C₄-alkyl, with at least one of the radicals R¹, R², R³, and R⁴ not being hydrogen; or R¹ and R² and/or R³ and R⁴ each together are C₂-C₅-alkylene, with one methylene group optionally being replaced by a carbonyl group; or R¹ and R³ together are C₂-C₅-alkylene, with one methylene group optionally being replaced by a carbonyl group; or R¹ and R² and/or R³ and R⁴, in each case together with the nitrogen atom to which they are attached, form a 5- or 6-membered unsaturated aromatic or nonaromatic ring which may further comprise one or two further nitrogen atoms or a sulfur atom or oxygen atom as ring member.

32. The curative according to claim 31, wherein component (v-2) is at least one amine having at least three primary and/or secondary amino groups.

33. The curative according to claim 1, wherein said at least one amine having at least two primary and/or secondary amino groups, of component (vi-2), is selected from amines of the formula I
NHR^{a}-A-NHR^{b} (I)
in which A is a divalent aliphatic, alicyclic, aliphatic-alicyclic, aromatic or araliphatic radical, with the aforementioned radicals also possibly being interrupted by a carbonyl group or by a sulfone group and/or possibly substituted by 1, 2, 3 or 4 radicals selected from C₁-C₄-alkyl; or is a divalent radical of the formula
[B—X]ₘ—B—
in which
each X independently is O or NR^{C}, in which R^{C} is H, C₁-C₄-alkyl, C₂-C₄-hydroxyalkyl or C₁-C₄-alkoxy;
each B independently is C₂-C₆-alkylene; and
m is a number from 1 to 100; and
R^{a} and R^{b} independently of one another are H, C₁-C₄-alkyl, C₂-C₄-hydroxyalkyl or C₁-C₄-alkoxy.

34. A composition comprising
(a) at least one condensation product as defined in claim 1;
(b) at least one epoxy resin which is in uncured or part-cured form; and
(c) optionally, at least one conventional epoxy resin curative.

35. The composition according to claim 34, wherein the components are in amounts such that the ratio of the number of all the reactive groups of the curatives (a) and (c) to the number of all of the epoxide groups in the epoxy resin (b) is 2:1 to 1:2.

36. A prepreg comprising the composition according to claim 34.

37. A cured epoxy resin obtained by a process comprising curing uncured or part-cured epoxy resin with a condensation product as defined in claim 1 and, optionally, at least one conventional epoxy resin curative.

38. The cured epoxy resin according to claim 37, comprising a reinforcing material.

39. The cured epoxy resin according to claim 38, the reinforcing material being selected from a glass fiber, a graphite fiber, a carbon fiber, and a polyaramid fiber.

40. The cured epoxy resin according to claim 39, wherein the cured epoxy resin is a laminate.

41. The cured epoxy resin according to claim 37, comprising a filler.

42. The cured epoxy resin of claim 41, wherein the filler is a mineral or a finely divided wood.

43. A method of curing an epoxy resin by admixing an uncured or part-cured epoxy resin with at least one condensation product as defined in claim 1, optionally, with at least one conventional epoxy resin curative and bringing the resulting mixture to a temperature of 5 to 150° C. or subjecting it to microwave radiation.

44. A cured epoxy resin obtained by a process comprising curing a composition according to claim 34.

45. A cured epoxy resin obtained by a process comprising curing a prepreg according to claim 36.
